(19) United States
(12) Patent Application Publication
(10) Pub. No.: US 2021/0211403 A1
(43) Pub. Date: Jul. 8, 2021

(54) CONTENT SERVER FOR PROVIDING APPLICATION UNIFICATION FOR PUBLIC NETWORK APPLICATIONS

(71) Applicants: Andrew Robinson, Kaneohe, HI (US); Alexei Tumarkin, Los Altos Hills, CA (US)

(72) Inventors: Andrew Robinson, Kaneohe, HI (US); Alexei Tumarkin, Los Altos Hills, CA (US)

(21) Appl. No.: 17/210,441

(22) Filed: Mar. 23, 2021

Related U.S. Application Data
(63) Continuation of application No. PCT/US19/52791, filed on Sep. 24, 2019.
Application No. PCT/US19/52791 is a continuation-in-part of application No. PCT/US19/52793, filed on Sep. 24, 2019.
Application No. PCT/US19/52793 is a continuation-in-part of application No. PCT/US20/52420, filed on Sep. 24, 2020.
Application No. PCT/US20/52420 is a continuation-in-part of application No. 16/816,170, filed on Mar. 11, 2020, now abandoned.

(51) Int. Cl. H04L 29/12; H04L 29/08; G06F 16/955

(52) U.S. Cl. CPC H04L 61/1511; H04L 67/02; G06Q 30/0613; H04L 67/2814; G06F 16/9558; H04L 67/2823

(57) ABSTRACT

Described is a content server for providing application unification for public network websites and applications. In this application the content server is a security platform that provides protection to an Internet publisher from third-party threats, protects from unauthorized data harvesting, and ensures enforcement for compliance requirements. No matter where end-users visit on Internet websites or cloud applications, the content server has security technology that ensures that all third-party applications are identified and enforce specific privacy, compliance and security requirements of the publisher. In general, the content server transparently identifies all third-party applications associated with a website or application. Each third-party is evaluated against multiple criteria to determine: what data is retrieved; their security posture/reputation; where data is transmitted (i.e., geo-location data); and additional third-party redirects. The content server provides high-speed processing of traffic between application/website visitors (i.e., end-users) and third-party application providers, with the ability to apply policies and rewrite data on the fly so as to apply multiple protection schemes. Each session is processed independently, and transparently to the end-user, ensuring the experience is unchanged from the expected application/website behavior.

### CROSS-REFERENCE TO RELATED APPLICATION AND CLAIM OF PRIORITY

The present application is a continuation of and claims priority to earlier filed PCT patent application No. PCT/US19/52791, filed on Sep. 24, 2019; and titled “Content Server For Providing Application Unification For Public Network Applications,” which claims priority to an earlier filed U.S. provisional patent application No. 62/735,617, filed on Sep. 24, 2018, and titled “System and Method for Providing Application Unification For Web Sites and Internet Applications,” both of which are hereby incorporated by reference in their entirety.

The present application is a continuation-in-part of and claims priority to earlier filed PCT patent application No. PCT/US19/52793, filed on Sep. 24, 2019; and titled “Virtual Private Network Environment For Application Unification Over A Public Network,” which claims priority to an earlier filed U.S. provisional patent application No. 62/735,617, filed on Sep. 24, 2018, and titled “System and Method for Providing Application Unification For Web Sites and Internet Applications,” both of which are hereby incorporated by reference in their entirety.

The present application is also continuation-in-part of and claims priority to earlier filed PCT patent application No. PCT/US/20/52420, filed on Sep. 24, 2020, and titled “Content Server For Mapping A Plurality of Third-Party Entities and Their Inter-dependencies For Information Content Accessed By A Computing Device Over A Network,” which claims priority to the earlier filed U.S, provisional patent application No. 62/905,351, filed on Sep. 24, 2019, and titled “Content Server For Mapping A Plurality of Third-Party Entities and Their inter-dependencies For Information Content Accessed By A Computing. Device Over A Network,” both of which are also hereby incorporated by reference in their entirety.

The present application is also continuation-in-part of and claims priority to earlier filed U.S., patent application Ser. No. 16/816,170, filed on Mar. 11, 2020, and tided “Content Server For Managing Media Data Between Publishers, Third-party Networks and a Computing Device,” which claims priority to US, provisional patent application. No. 62/817,996, filed on Mar. 13, 2019, and titled “Content Server For Managing Media Data Between Publishers, Third-party Networks and a Computing Device,” both of which are also hereby incorporated by reference in their entirety.

### BACKGROUND

### 1. Field

The present disclosure is related to computing systems that communicate over a network, and more specifically, to computing systems that receive, modify, and transfer data over a network.

### 2. Related Art

At present, electronic commerce (“e-commerce”) has become a large portion of the world economy. As more businesses provide on-line access to a customer's information and/or offer to sell products or services over the Internet to the customer, more customers correspondingly interact with these businesses over a public network such as, for example, the Internet. To interact with these businesses over the Internet, end-users (e.g., customers) utilize computing devices that have operating system software that runs one or more Internet browsers (generally referred to as “web browsers” or simply “browsers”) that connect to and interact with web sites run and managed by businesses over the World Wide Web (generally referred to simply as “the Web”). These websites include website applications that display information on a webpage of the browser of the computing device that is connected to the web site. The websites are text files that utilize hypertext markup language (“HTML”) or other similar markup language (for simplicity referred to herein as just “HTML”).

These website applications (generally referred to as “Web applications” or “Web apps”) include content (such as, for example, end-user desired content, financial information, advertisement, health related information, music, videos, etc.), images, trackers, customer relationship management (“CRM”) services and business intelligence applications. Typically, these web sites often include content, such as images and inline frames (i.e., HTML documents embedded inside another HTML document of a website known as “iframes”), located on servers controlled by second-party and/or third-party entities. A browser loading an HTML webpage will contact these additional servers directly to satisfy external content dependencies within the webpage. As such, some of these Web apps are run by servers controlled and managed by the corresponding business hosting the website and some of the other Web apps are run off-site by second-party and/or third-party entities that control and manage these Web apps instead of the business hosting the website.

Unfortunately, the functionality offered by these Web apps (that are run off-site from the originally accessed website) introduce visibility and unification concerns that cannot be addressed by existing systems and procedures. Specifically, these types of functionality have multiple security and privacy implications because they include context related to the browsing history of an end-user and they lack transparency since an address bar of a browser only displays the address of the website visited directly. Moreover, “social plugins” enable websites to offer personalized content by leveraging the social graph, and allow their visitors to seamlessly share, comment, and interact with their social circles. These plugins are provided by services, such as, for example, Facebook Inc., of Menlo Park, Calif., and are embedded by developers in the form of iframes in the websites that end-users might visit, for instance, to read the news or shop. Once an end-user activates an iframe, the end-user will be directed to a new website controlled and managed by a third-party entity that is not controlled by the first-party entity (i.e., the original business that controlled and managed the original website that the end-user accessed). As such, with this functionality comes the possibility of compromising the privacy of an end-user which may lead to liability (for example a lawsuit and/or a general data protection regulation (“GDPR”) violation in Europe) on the part of the first-party entity even though the privacy of the end-user was compromised by a third-party entity that is beyond the control of the first-party entity.

At present, more and more businesses that are hosting websites and Web apps are relying on both second-party and third-party entities to delivery key functions on their hosted websites and Web apps. These key functions may include the already discussed content, trackers, CRM services and business intelligence applications. As a result, these second-party and third-party entities have access to website visitors (i.e., the end-users) and the associated data and may, in turn, share that information with or redirect those website visitors to other third-party entities. Consequently, as public networks, such as the Internet, expand and improve, the general public of end-users, enterprise systems, employees and partners, interact (often unknowingly) with an expanding universe of first-parties, second-parties and third-parties.

In this application, the term first-party entity (or simply “first-party”) refers to primary services such as businesses that run and manage websites and Web apps that end-users want to reach and utilize. Second-party entities (or simply “second-party”) are first-party approved and agented parties (i.e., entities) that operate under the authority and act as an agent on behalf of the first-party. Generally, businesses that operate and manage websites delegate part of the content and/or functionality of the web site to a second-party entity operating under a subdomain of the website managed and controlled by the first-party entity. Examples of known second-party entities include content delivery networks and same-site analytics services. Such second-party entities are commonly obligated under contract to share data with the first-party and are controlled and configurable according to the preferences of the first-party. Conversely, third-party entities deliver services through their own distinct domains and have symbiotic relationships to websites of the first-parties. As such, first-parties only have circumstantial knowledge and control over the operations of the third-party entities. Examples of known third-party entities include cross-site social or advertising services.

In addition to the previous concerns, with the increase in e-commerce, the associated hardware and software applications related to commercial use over the Internet have improved, increased, and diversified to the point of creating “Cloud” based systems on the Internet. These Cloud based systems created “Cloud Computing” applications that are on-demand applications that allow individual end-users and/or businesses to access computer system resources, especially data storage and computer power, without the direct active management by the end-user or business. These improvements have resulted in enterprises moving to and utilizing cloud services and Software-as-a-Service (“SaaS”) applications instead of self-hosted ones, which creates a mishmash of heterogeneous data sources and transactions over which enterprises and their employees have no control. For example, if an enterprise portal includes “feeds” from multiple third-party entities acting as SaaS providers, then the transactions performed by employees on these SaaS providers cannot be visible in real time by the enterprise and are only auditable through special arrangements with such providers.

Furthermore, in the case of an enterprise (i.e., a business), the utilization of third-party entities results in possible security, privacy, and data unification issues that include, for example, data exposure, malware distribution and insertion, information leakage, and regulatory non-compliance. Security and privacy issues arise as a result of the first-party entity not being able to control the third-party entity leading to an end-user and/or the first-party entity being susceptible to any privacy invading actions and/or security flaws at the third-party or malevolent acts performed by the third-party entity. Examples of privacy invading actions include obtaining personal information from the end-user and utilizing it for purposes that the end-user and/or first-party entity did not intend. This also includes loading programs on to the computing device of the end-user without the knowledge of the end-user and/or first-party entity. Moreover, malevolent acts include the inserting malware on the computing device of the end-user without the knowledge and consent of the end-user. The security issues include use of the information of the end-user that violate codes of conduct or even laws of certain jurisdictions and potential security vulnerabilities at the third-party entity that may allow an external party to enter the server of the third-party entity and compromise the information of end-users that accessed, or where part of, the customer data of the first-party entity leading to potential fraudulent activity against some of those end-users and the resulting financial liability of the first-party entity that allowed the comprising of that customer data.

Moreover, third-party entities may unilaterally change the way that they do business with a first-party entity, preventing the first-party entity to properly either monetize or use data from their own customers (i.e., the end-users). Unfortunately, in these situations, customer data (i.e., data from the end-user) are shared with a broad range of application providers (i.e., third-party entities) and the provider relationships (i.e., first-party entity to third-party entity relationships) are constantly changing. Furthermore, a compromised provider (i.e., third-party entity) may become a source of threats or breach for the first-party entity.

For a website of a publisher (i.e., enterprise), content is king in that the content of the website is what draws and engages end-users for all of the content of the publisher. Usually quality content equates to more end-users and more engagement for the web site of the publisher. Generally, the publisher needs to monetize this content whether through subscription, advertising or other means. In the advertising ecosystem of e-commerce, third-party entity tag and data nature of the advertising ecosystem is an attractive technology for monetizing this content because it allows fast integration and data sharing between multiple partners (i.e., the first-party entity and second-party and third-party entities); however, this advertising ecosystem may also become detrimental to the economic success of the publisher, when a third-party entity unilaterally decides to change what it is doing. As an example, the intelligent tracking prevention 2.0 (“ITP”) application, produced by Apple Computer, Inc. of Cuppertino, Calif., is a third-party entity Web App that stopped sharing customer information with first-party entities.

Furthermore, it becomes more difficult for the first-party entity to control data and transaction reliability and the end-user experience when the first-party entity utilizes redirects over the Internet to redirect end-users to new content producing or data recording and/or processing third-party entity servers that allow totally independent third-party entities to control the user experience of the end-user and may damage the relationship between the end-users and publisher. The damage to the relationship may be the result of quality issues such as, for example, quality of service, latency delays, and security and privacy issues. As an example of problems with transaction reliability, when the hypertext transfer protocol (“HTTP”) cookies (also known as a web cookies, Internet cookies, browser cookies, or simply as “cookies”—a small piece of data sent from a website and stored on the computing device of the end-user by web browser while the end-user is browsing the Internet) or data of an end-user is passed between multiple third-party applications (that may be utilized for “synching” or maintaining session persistence), the cookies and data cannot be assumed to be 100% reliable and could result in “lost” or “corrupted” data and/or indefinite delayed communications between the end-user and third-party entities.

As a result of these problems and others, there is a desire for implementing some type of data unification; however, data unification is another enterprise challenge because data unification is the process of ingesting, transforming, mapping, de-duplicating and exporting data from multiple sources. In general, data unification is a benefit for an enterprise because it allows the enterprise to unify its varying data sources and, therefore, produce a body of knowledge about its business. As an example, a procurement officer, when purchasing, for example, paperclips from a first supplier, is only able to see the information in his/her database about his/her relationship with the first supplier. When the contract of the first supplier comes up for renewal, he/she would likely want to know the terms and conditions negotiated with the first supplier by other business units of the enterprise, so that he/she can demand a “most favored nation” status.

An example of this body of knowledge about the enterprise, data unification includes a method for producing a single customer view (“SCV” that is also referred to as a “360” or “unified” customer view). The SCV is a method of gathering all the data about the customers of an enterprise and merging it into a single record. By consolidating every piece of information about the customers (i.e., end-users) of the enterprise into one centralized location, the enterprise acquires a powerful overview of every action performed by all of its customers—on the computing devices (e.g., computers, mobile devices, etc.), on website of the enterprise, or even in a brick-and-mortar store of the enterprise. Thus, the SCV may be an aggregated, consistent and holistic representation of the data known by the enterprise about its customers. In this example, the SCV is mostly composed of data that meets the definition of first-party entity data—the information that a brand or company collects itself and owns. Generally, this first-party entity data is much more valuable than filtered and indirectly accessible third-party data because the first-party entity data not stripped of personal identifiers and is directly collected by the first-party entity without any third-party entity anonymization, aggregation and delayed post-processing.

However, establishing data unification in an enterprise is not a simple process because, typically, the process involves human beings constructing a global schema upfront, discovering and converting local schemas into the global schema, writing programs that include cleaning and transformation routines, and creating a collection of rules for matching and merging data. Unfortunately, it routinely takes between three to six months to perform this process for each data source. As an example, performing this process on an enterprise having approximately 80 procurement systems that contain information about its global suppliers would take up to about 40 person-years to complete. Even by applying human parallelism, this process would typically still be a multi-year project that would cost the enterprise millions of dollars.

As an example illustrating the above discussed problems, in FIG. 1, a system block diagram is shown of an example of a known e-commerce communication system 100 between a computing device 102 and a plurality of Internet publishers 104, 106, and 108 over a public network 110 such as the Internet. The computing device 102 may be, for example, a personal computer 112 (including a desktop, tower, or other similar devices), portable computer 114 (including a laptop, notebook, or tablet computer, or other similar devices), mobile device 116 (including a tablet, smartphone, or other similar devices), server 118, or other type of computing device capable of connecting to the plurality of Internet publishers 104, 106, and 108 over the Internet 110 such as video gaming counsels, or other smart devices. In general, the computing device 102 is operated by an end-user 120 via a browser 122 running on the display screen 124 of a video display 126 of the computing device 102.

In this example, the plurality of Internet publishers 104, 106, and 108 are each first-party entities that contain information that the end-user 120 desires access to. In order to receive that information, the end-user 120 enters an Internet address of a publisher of the plurality of Internet publishers 104, 106, and 108 into an address line 128 of the browser 122. For example, that Internet address may direct the computing device 102 to a first publisher 104, via signal path 129, that runs a website 130. The website 130 will include blocks 132 of data and/or content, some of which the end-user 120 desires to access. Once the browser 122 connects to the website 130 of the publisher 104, the browser 122 will display the website 130 within a webpage 134 produced by the browser 122. In this example, the webpage 134 will display blocks 136 of data and/or content that may be the same or related to the blocks 132 on the website 130. In general, some of the blocks 132 on the website 130 may be produced by the publisher 104 and some of the other blocks 132 may be produced by second-party and/or third-party entities (i.e., entities that are not the publisher 104). Similarly, some of the blocks 136 on the webpage 134 may be produced by the publisher 104 and some of the other blocks 132 may be produced by second-party and/or third-party entities. In general, some of the blocks 136 of the webpage 134 may be different than the blocks 132 of the website 130 because blocks 136 of the webpage 134 may be personalized to the computing device 102 and/or end-user 120. Examples of the plurality of Internet publishers 104, 106, and 108 may include financial institutions (i.e., banks, investment firms, etc.), health providers, on-line retailers, news agencies, search engines, cloud computing services, on-line games, media content providers, etc.

Turning to FIG. 2, a system block diagram is shown of an example of the known e-commerce communication system 100 shown and discussed in relation to FIG. 1 with second-party entities 200 and third-party entities 202. In this example, the publisher 104 is again shown in signal communication with the computing device 102 via the signal path 129 (shown in FIG. 1) that runs through the Internet 110. The publisher 104 is also shown to have relationships with, for example, a second-party entity of the second-party entities 204 and three or more third-party entities 204, 206, and 208. The relationships between the publisher 104 and the second-party entity of the second-party entities 204 and the three or more third-party entities 204, 206, and 208 are shown as dotted-line paths 210, 212, 214, and 216, respectively. These relationships may be, for example, contractual relationships between the publisher 104 and the second-party entities 204 and three or more third-party entities 204, 206, and 208 to provide services to the end-user 120 and/or publisher 104, where the publisher 104 includes software code within the blocks 132 of the website 130, hosted by the publisher 104, that will redirect requests to the publisher 104 from the end-user 120 utilizing the computing device 102 via the webpage 134. It is noted that the relationship dotted-line paths 210, 212, 214, and 216 are shown solely for the purposes of establishing that the publisher 104 has some type of relationship with the second-party entity of the second-party entities 204 and the three or more third-party entities 204, 206, and 208 but are generally not signal paths that establish direct communication between the publisher 104 and the second-party entities 204 and the three or more third-party entities 204, 206, and 208. Specifically, the computing device 102 will not communicate with the second-party entity of the second-party entities 204 and the three or more third-party entities 204, 206, and 208 via the publisher 104.

In this example, the third-party entities 202 are shown divided into first-tier 218, second-tier 220, and third-tier 222 third-party entities 202. The first-tier 218 includes the three or more third-party entities 204, 206, and 208. Similarly, the second-tier 220 includes another three or more third-party entities 224, 226, and 228. For simplicity the third-tier 222 is shown including at least one third-party entity 230. Similar to the situation described earlier with relation to the publisher 104, each third-party entity 204, 206, 208, 224, 226, 228, and 230 may include one or more relationships to other third-party entities. Generally, there is no limit to the number and combination of relationships that may exist between the third-party entity 204, 206, 208, 224, 226, 228, and 230 and other third-party entities. As an example, the third-party entity 204 (of the first-tier 218) is shown having at least three relationships (shown as dotted-line paths 232, 234, and 236) with the third-party entities 224, 226, and 228, respectively. Again, these relationships are similar to the relationships described in relation to the relationship dotted-line paths 210, 212, 214, and 216 shown for the publisher 104. It is appreciated by those of ordinary skill in the art that the relationships may also be shown from any of the third-party entities 224, 226, and 228 of the second-tier 220 and the at least one third-party entity 230 or other third-party entities (not shown) of the third-tier 222 or of other number of tiers (not shown).

In an example of operation, the end-user 120 utilizes the webpage 134 in the browser 122 (that is running on the computing device 102) to access the website 130 running on the publisher 104. The end-user 120 may provide the publisher 104 with an end-user data 238 that is sent from the browser 122, running on the computing device 102, to the publisher 104 via signal path 129. In this example, the signal path 129 is one of a plurality of signal paths 240 that are in signal communication with the computing device 102. The other signal paths 242, 244, 246, 248, 250, 252, 254, and 256, respectively, are signal paths from the computing device 102 to the second-party entities 200, third-party entities 204, 206, and 208 of the first-tier 218, third-party entities 224, 226, and 228 of the first-tier 220, and the third-party entity 230 of the third-tier 222. In this example, part of the end-user data 238 will be transmitted from the computing device 102 to the publisher 104 via signal path 129 and other parts of the end-user data 238 will be transmitted from the computing device 102 to the second-party entities 200 and third-party entities 202 via signal paths 242, 244, 246, 248, 250, 252, 254, and 256. The signal paths 242, 244, 246, 248, 250, 252, 254, and 256 are the result of the publisher 104 including software code in some of the blocks 132 of the website 130 that are passed to some of the blocks 136 of the webpage 134 shown on the browser 122 of the computing device 102. This software code when run of the webpage 134 directs the browser 122 of the computing device 102 to establish a connection to an Internet address of the corresponding second-party entities 200 or third-party entities 202 to which the publisher 104 has a relationship. In general, the software code may be a hyperlink that when activated by the end-user 120 may direct the browser 122 to a server that is external to the publisher 104 and will communicate directly with computing device 102.

In general, the publisher 104 utilizes this type of software code to send some or all of the end-user data 238 to the second-party entities 200 and/or the third-party entities 202 to delegate part of the content and/or functionality of the website 130 run and/or managed by the publisher 104. Based on the previously established relationship, if the publisher 104 sends part or all of the end-user data 238 or redirects the webpage 134 to the second-party entities 200, the second-party entities 200 are commonly obligated to share the end-user data 238 with the publisher 104 (i.e., the first-party) and are controlled and configurable according to the preferences of the publisher 104. As an example, the publisher 104 may be content delivery network and a second-party entity of the second-party entities 200 may be an analytics service.

Alternatively, the third-party entities 202 are generally independent entities that the publisher 104 only has circumstantial knowledge and control over their operations. As an example, the publisher 104 may be a cross-site social website and/or service and the third third-party entities 202 may be advertising services. However, unlike the second-party entities 200, when the third-party entities 202 receive part of all of the end-user data 238 or simply the browser 122 is redirected to one of the third-party entities 202, that end-user data 238 may be shared or sent and/or the browser 122 may be redirected to other third-party entities 202 not known to, or controllable by, the publisher 104 (e.g., the third-party entities 202 of the second-tier 220, third-tier 222, or more). As an example, if the first third-party entity 204 receives part of or all of the end-user data 238 or a redirect of the browser 122, the first third-party entity 204 may then share or send that end-user data 238 or again redirect the browser 122 to the second-tier 220 of third-party entities 202. Similarly, a first third-party entity 224 of the second-tier 220 may receive the part of or all of the end-user data 238 or browser 122 redirect from the first third-party entity 204 and further share that part of or all of the end-user data 238 or redirect the browser 122 with a plurality of third-tier 222 of third-party entities 202 (i.e., third-party entity 230), and so on. In each of these examples, the software code activated by the browser 122 establishes direct signal communication (via signal paths 250, 252, 254, and 256) with the second-tier 220 and third-tier 222 third-party entities 202. As a result, these signal paths 250, 252, 254, and 256 are invisible and unknown to both the end-user 120 and the publisher 104 where the publisher 104 is generally only aware of the first-tier 218 third-party entities 202 and the end-user 120 is only aware of the publisher 104 and generally believes that their end-user data 238 is being utilized exclusively by the publisher 104.

Unfortunately, it is appreciated by those of ordinary skill in the art that the present situation for e-commerce described introduces risk management issues. In this situation, the publisher 104 and end-user 120 do not know where the end-user data 238 goes. This may lead to security issues and compliance liabilities enabled by the third-party entities 202. Furthermore, as discussed earlier, the redirects over the Internet to new content producing or data recording and/or processing servers will allow totally independent third-party entities 202 to control the user experience of the end-user 120 and may damage the relationship between the end-user 120 and publisher 104 because of quality issues such as, for example, quality of service, latency delays, and security and privacy issues. As such, there is a need for a system and method that addresses these problems.

### SUMMARY

Described is a content server for providing application unification for public network websites and applications. In this application the content server is a security platform that provides protection to an Internet publisher from third-party threats, protects from unauthorized data harvesting, and ensures enforcement for compliance requirements. No matter where end-users visit on Internet websites or cloud applications, the content server has security technology that ensures that all third-party applications are identified and enforce specific privacy, compliance and security requirements of the publisher. In general, the content server transparently identifies all third-party applications associated with a website or application. Each third-party is evaluated against multiple criteria to determine: what data is retrieved; their security posture/reputation; where data is transmitted (i.e., geo-location data); and additional third-party redirects. The content server provides high-speed processing of traffic between application/website visitors (i.e., end-users) and third-party application providers, with the ability to apply policies and rewrite data on the fly so as to apply multiple protection schemes. Each session is processed independently, and transparently to the end-user, ensuring the experience is unchanged from the expected application/website behavior.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of a known e-commerce communication system between a computing device and a plurality of Internet publishers over a public network such as the Internet.

FIG. 2 is a system block diagram of an example of the known e-commerce communication system shown in FIG. 1 with second-party and third-party entities.

FIG. 3 is a system block diagram of an example of an implementation of a communication system between a computing device and a publisher over a public network such as the Internet in accordance with the present disclosure.

FIG. 4 is a system block diagram of an example of an implementation of the communication system, shown in FIG. 3, between the computing device, publisher, and multiple tiers of the third-party entities accordance with the present disclosure.

FIG. 5 is a system diagram is shown illustrating an example of another implementation of the system environment shown in FIGS. 3 and 4, where the content server manages data in accordance with the present disclosure.

FIG. 6 is a system diagram of an example of an implementation of components of a device of the content server shown in FIG. 5 in accordance with the present disclosure.

FIG. 7 is a system diagram of an example of an implementation of the display of the computing device in accordance with the present disclosure.

FIG. 8 is a system block diagram of an example of another implementation of a content server in accordance with the present disclosure.

FIG. 9 is a block diagram illustrating the core elements of the content server shown in FIGS. 3-8 in accordance with the present disclosure.

FIG. 10 is a block diagram of a communication system for risk monitoring with the content server shown in FIGS. 3-8 in accordance with the present disclosure.

FIG. 11 is a block diagram of the communication system for active containment with the content server shown in FIGS. 3-8 and 10 in accordance with the present disclosure.

FIG. 12 is a block diagram of the communication system for anomaly detection with the content server shown in FIGS. 3-8 and 10-11 in accordance with the present disclosure.

FIG. 13 is a block diagram of the communication system for threat detection and/or reputation determination with the content server shown in FIGS. 3-8 and 10-12 in accordance with the present disclosure.

FIG. 14 is a block diagram of a communication system for active out-of-band monitoring with the content server shown in FIGS. 3-8 and 10-13 in accordance with the present disclosure.

FIG. 15 is a flowchart of an example of an implementation of a method performed by the content server shown in FIGS. 3-8 and 10-14 in accordance with the present disclosure.

FIG. 16 is a flowchart of an example of another implementation of a method performed by the content server shown in FIGS. 3-8 and 10-14 in accordance with the present disclosure.

FIG. 17 is a flowchart of an example of yet another implementation of a method performed by the content server shown in FIGS. 3-8 and 10-14 in accordance with the present disclosure.

FIG. 18 is a flowchart of an example of yet another implementation of a method performed by the content server shown in FIGS. 3-8 and 10-14 in accordance with the present disclosure.

### DETAILED DESCRIPTION

Described is a content server for providing application unification for public network websites and applications. In this application the content server is a security platform that provides protection to an Internet publisher from third-party threats, protects from unauthorized data harvesting, and ensures enforcement for compliance requirements. No matter where end-users visit on Internet websites or cloud applications, the content server has security technology that ensures that all third-party applications are identified and enforce specific privacy, compliance, and security requirements of the publisher. In general, the content server transparently identifies all third-party applications associated with a website or application. Each third-party is evaluated against multiple criteria to determine: what data is retrieved; their security posture/reputation; where data is transmitted (i.e., geo-location data); and additional third-party redirects. The content server provides high-speed processing of traffic between application/web site visitors (i.e., end-users) and third-party application providers, with the ability to apply policies and rewrite data on the fly so as to apply multiple protection schemes. Each session is processed independently, and transparently to the end-user, ensuring the experience is unchanged from the expected application/website behavior.

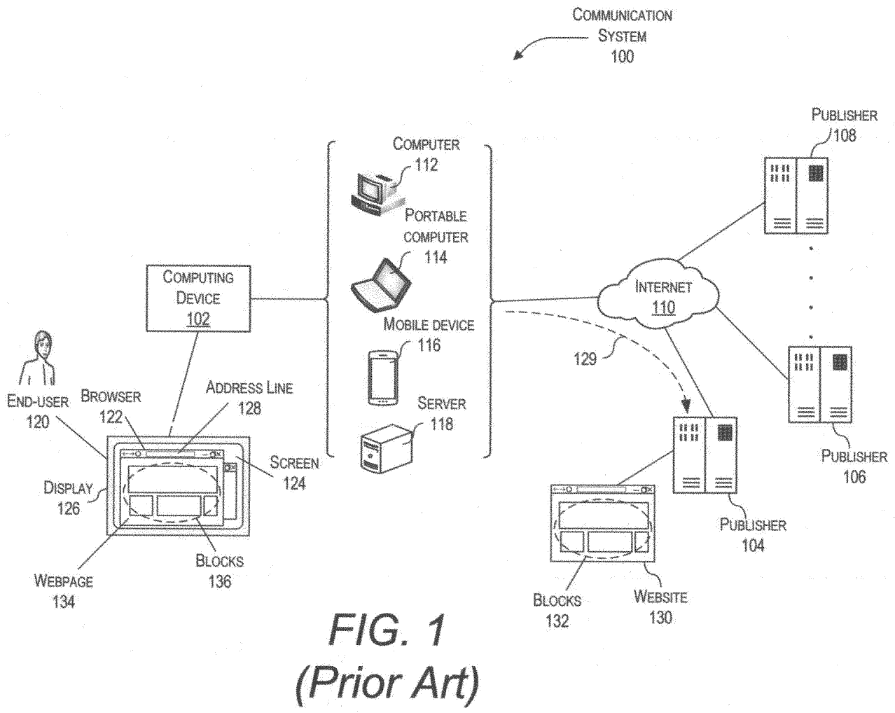

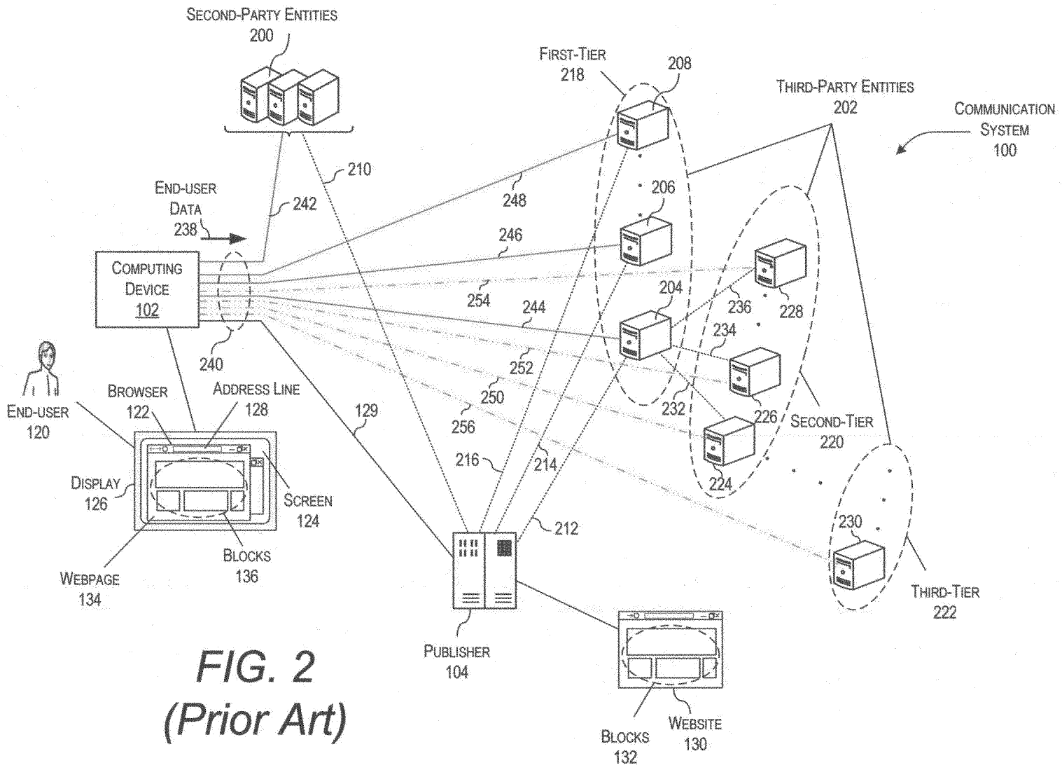

Various examples, scenarios, and aspects are described below with reference to FIGS. 1-18.

In general, the present application describes a content server for providing application unification for one or more public network websites and website applications being accessed by a computing device over a public network. The one of more public network websites may generally referred to as Internet publishers (or simply “publishers”). The content server may include one or more processing units and a computer-readable media (also known as a computer-readable medium) storing instructions. The stored instructions when executed by the one or more processing units, cause the content server to perform operations that include receiving, as an intermediary, a request from the computing device for information content from a specific public network website (also referred to as a specific public network site) of the one or more public network sites and applications, requesting the information content from the specific public network, receiving, from the specific public network, the information content within a first data. Furthermore, the stored instructions when executed by the one or more processing units, further cause the content server to perform operations that also include detecting a link for external information within the information content, wherein the external information is located on an external server that is external to the specific public network, receiving the external information from the external server, modifying the information content with the external information to produce a modified information content, sending the modified information content to the computing device.

Generally, in this application, these website applications (generally referred to as “Web applications” or “Web apps”) include content (such as, for example, end-user desired content, financial information, advertisement, health related information, music, videos, etc.), images, trackers, customer relationship management (“CRM”) services and business intelligence applications. Typically, these websites often include content, such as images and inline frames (i.e., HTML documents embedded inside another HTML document of a website known as “iframes”), located on servers controlled by second-party entities and/or third-party entities. A browser loading an HTML webpage will contact these additional servers directly to satisfy external content dependencies within the webpage. As such, some of these Web apps are run by servers controlled and managed by the corresponding business hosting the website (i.e., a first-party entity generally referred to as a publisher) and some of the other Web apps are run off-site by second-party entities and/or third-party entities that control and manage these Web apps instead of the publisher hosting the website.

As discussed earlier, the functionality offered by these Web apps (that are run off-site from the originally accessed website of the publisher) introduce visibility and unification concerns because they include context related to the browsing history of an end-user and they lack transparency since an address bar of a browser only displays the address of the website visited directly by the end-user. Some of these Web apps are plugins that are provided by services and are embedded by developers in the form of iframes in the websites that end-users might visit, for instance, to read the news or shop. Once an end-user activates an iframe with the browser, the end-user is directed to a new web site controlled and managed by a third-party entity that is not controlled by the publisher (i.e., the first-party entity that is the original business that controls and manages the original website that the end-user accessed). As such, with this functionality comes the possibility of compromising the privacy of an end-user which may lead to liability on the part of the publisher even though the privacy of the end-user was compromised by a third-party entity that is beyond the control of the publisher.

In this application, the terms publisher and/or first-party entity (or simply “first-party”) refers to primary services such as a business that runs and manages at least one website and/or Web app that end-users want to reach and utilize. Second-party entities (or simply “second-party”) are first-party approved and agented parties (i.e., entities) that operate under the authority and act as an agent on behalf of the publisher. As discussed earlier, publishers that operate and manage websites generally delegate part of the content and/or functionality of the website to a second-party entity operating under a subdomain of the website managed and controlled by the publisher. Examples of known second-party entities include content delivery networks and same-site analytics services. Such second-party entities are commonly obligated under contract to share data with the publisher and are controlled and configurable according to the preferences of the publisher. Conversely, third-party entities deliver services through their own distinct domains and have symbiotic relationships to websites of the publisher. As such, publishers only have circumstantial knowledge and control over the operations of the third-party entities. Examples of known third-party entities include cross-site social or advertising services.

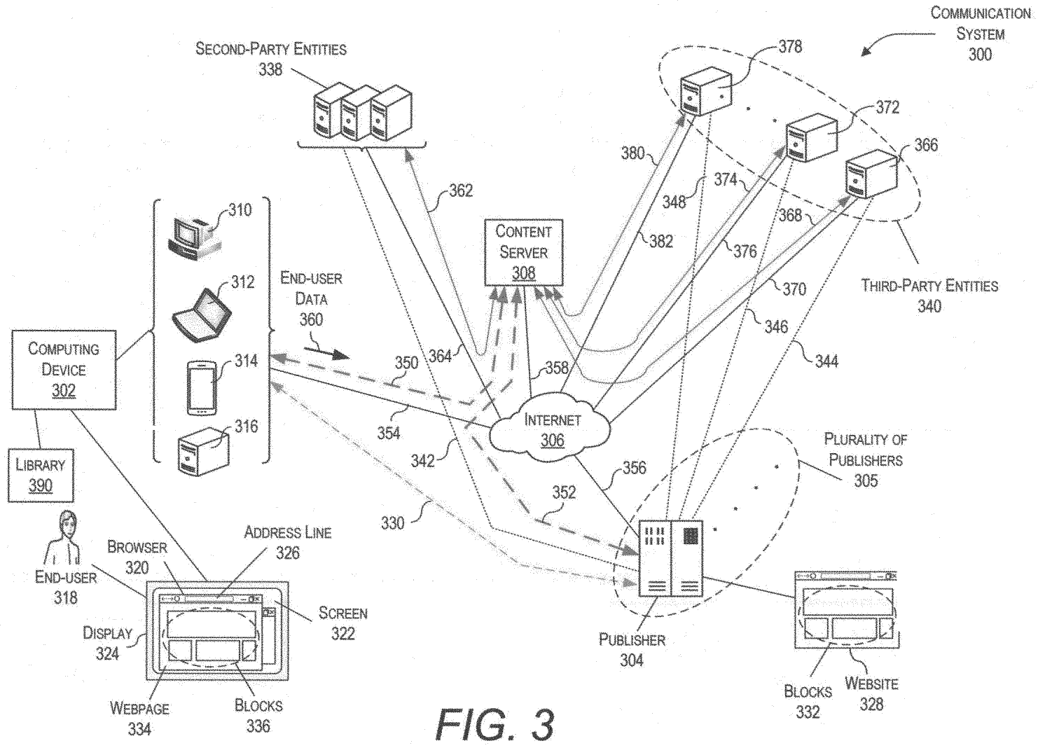

In FIG. 3, a system block diagram of an example of a communication system 300 between a computing device 302 and a publisher 304 over a public network such as, for example, the Internet 306 is shown in accordance with the present disclosure. The communication system 300 includes the computing device 302, publisher 304 and a content server 308. In this example, for the simplicity of illustration, only a single publisher 304 is shown, however, it is appreciated by those of ordinary skill that the communication system 300 includes a plurality of publishers 305.

The computing device 302 may be, for example, a personal computer 310 (including a desktop, tower, or other similar devices), portable computer 312 (including a laptop, notebook, or tablet computer, or other similar devices), mobile device 314 (including a tablet, smartphone, or other similar devices), server 316, or other type of computing device capable of connecting to the publisher 304 over the Internet 306 such as video gaming counsels, or other smart devices. In general, the computing device 302 is operated by an end-user 318 via a browser 320 running on the display screen 322 of a video display 324 of the computing device 302.

In this example, the plurality of Internet publishers 305 (including publisher 304) are each first-party entities that contain information that the end-user 318 desires access to. In order to receive that information, the end-user 318 enters an Internet address of the publisher 304 (of the plurality of Internet publishers 305) into an address line 326 of the browser 320. In this example, the publisher 304 runs a website 328 (or web application or enterprise portal) that has an Internet protocol (“IP”) address that if entered in the browser 320 would normally direct the computing device 302 to the publisher 304 via a signal path 330 if the content server 308 were not present. The website 328 includes blocks 332 of data and/or content, some of which the end-user 318 desires to access. Without the content server 308 present, once the browser 320 connects to the website 328 of the publisher 304, the browser 320 displays the website 328 within a webpage 334 produced by the browser 320.

In this example, the webpage 334 will display blocks 336 of data and/or content that may be the same or related to the blocks 332 on the website 328. In general, some of the blocks 332 on the website 328 may be produced by the publisher 304 and some of the other blocks 332 may be produced by second-party entities 338 and/or third-party entities 340 (i.e., entities that are not the publisher 104). Similarly, some of the blocks 336 on the webpage 334 may be produced by the publisher 304 and some of the other blocks 336 may be produced by second-party entities 338 and/or third-party entities 340. In general, some of the blocks 336 of the webpage 334 may be different than the blocks 332 of the website 328 because blocks 336 of the webpage 334 may be personalized to the computing device 302 and/or end-user 318. Examples of the plurality of publishers 305 may include financial institutions (i.e., banks, investment firms, etc.), health providers, on-line retailers, news agencies, search engines, cloud computing services, on-line games, media content providers, etc.

In this example, the publisher 304 is also shown to have relationships with, for example, the second-party entities 338 and the third-party entities 340. The relationships between the publisher 304 and the second-party entities 338 and the third-party entities 340 are shown as dotted-line paths 342, 344, 346, and 348, respectively. These relationships may be, for example, contractual relationships between the publisher 304 and the second-party entities 338 and the third-party entities 340 to provide services to the end-user 318 and/or publisher 304, where the publisher 304 includes software code within the blocks 332 of the website 328, hosted by the publisher 304, that will redirect requests to the publisher 304 from the end-user 318 utilizing the computing device 302 via the browser 320. It is noted that the relationship dotted-line paths 342, 344, 346, and 348 are shown solely for the purposes of establishing that the publisher 304 has some type of relationship with the second-party entities 338 and the third-party entities 340 but are generally not signal paths that establish direct communication between the publisher 304 and the second-party entities 338 and the third-party entities 340. Specifically, the computing device 302 will not communicate with the second-party entities 338 and the third-party entities 340 via the publisher 304. It is also noted that the third-party entities 340 may include a plurality of third-party entities that may be divided into multiple tiers of third-party entities that may be “chained” together into different combinations. Similar to the situation described earlier with relation to the publisher 304, each third-party entity of the third-party entities 340 may include one or more relationships to other third-party entities. Generally, there is no limit to the number and combinations of relationships that may exist between the third-party entities 340.

It is appreciated by those skilled in the art that the circuits, components, modules, and/or devices of, or associated with, the content server 308 are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

In an example of operation, the end-user 318 utilizes the webpage 334 in the browser 320 (that is running on the computing device 302) to access the website 328 (or web application or enterprise portal) running on the publisher 304. Since the content server 308 is present in the communication system 300, the signal path 330 directly from the computing device 302 to the publisher 304 does not exist because the all communications between the computing device 302 and the publisher 304 will be controlled and managed by the content server 308 via signal paths 350 and 352. The content server 308 is a proxy server that acts as an intermediary for requests from clients (i.e., the computing device 302) seeking resources from other servers (i.e., the publisher 304). Specifically, the content server 308 is a “unity hub” that intercepts the request from the browser 320 and acts on behalf of the publisher 304 in a manner that may be transparent to the computing device 302, browser 320, and end-user 318.

It is appreciated by those of ordinary skill in the art that the content server 308 may intercept the requests from the browser 320 by utilizing various interceptions mechanisms. For example, the content server 308 may utilize domain name system (“DNS”) delegation where the publisher 304 delegates DNS resolution to the content server 308. As another example, content server 308 may be deployed in a physical or virtual datacenter of the customer (i.e., publisher 304) as a front-end proxy. Moreover, in another example, the content server 308 acts in the place of an existing origin in a content delivery network (“CDN”) configuration when the publisher 304 utilizes a CDN for delivery of an end-user data 360 from the computing device 302.

As discussed earlier, the content server 308 is a proxy server or a proxy-like module that intermediates all or selected interactions between parties (i.e., the end-users such as end-user 318 and the publisher 304). In general, the content server 308 receives requests for content from end-users (i.e., end-user 318) and relays the requests to second-party entities 338, third-party entities 340, or both. The content server 308 provides the publisher 304 with flexibility when deployed against websites and Web apps because the content server 308 may operate in a monitoring mode, active out-of-band mode, and active protection mode.

In the monitoring mode, the content server 308 remotely monitors the third-party entities 340 and their corresponding Web apps, providing regular reports on each third-party entity of the plurality of third-party entities 340. In this example, the content server 308 can remotely retrieve a third-party Web app (from the third-party entity of the third-party entities 340) from the website 328 or Web app (of the publisher 304) directly by inspecting the “tags” embedded in the website 328 itself. In this example, the content server 308 may be a software and/or hardware module that may be optionally integrated with a Tag Manager of the website and/or Web app of the publisher 304 so as to provide a more comprehensive list of integrated functions from the third-party entities 340. In this example, the content server 308 may produce a report that includes third-party entity security posture and/or reputation, third-party entity geo-location, and additional third-party entity redirects. From this report, administrators of the publisher 304 are better equipped to make decisions on whether to remove or replace individual third-party entity website and/or Web apps.

In the active out-of-band mode, the content server 308 is deployed in the same way as in the monitoring mode but is integrated with the Tag Manager of the web site 328 and/or Web app of the publisher 304. When the content server 308 is in the active out-of-band mode, the content server 308 monitors the third-party entities 340 and if a third-party entity violates the policies of the content server 308 (policies that may be dictated by the publisher 304), the content server 308 can then dynamically remove the third-party entity from the website 328 and/or Web app of the publisher 304 to ensure the protection of the customer data of the end-user 318, and threats are not introduced by the third-party entity.

In the active protection mode, the content server 308 is deployed in-line between the customers (i.e., the end-user 318 utilizing the computing device 302) and the website 328 and/or Web app of the publisher 304. In this example, the content server 308 is a high-speed proxy that scales with customer traffic, and can actively protect from threats, and ensure that customer data of the end-users (including end-user 318) is protected at all times.

In this example, each interaction is seamlessly redirected from the end-user 318 to the content server 308. The request is forwarded on to the intended destination (i.e., the publisher 304), with all of the interaction between the publisher 304 and the third-party entities 340 controlled by the content server 308. In this example, if threat intelligence is added to the content server 308, the threat intelligence provides the content server 308 with the ability to eliminate threat sources from the third-party entities 340 immediately. Moreover, if any third-party entity requests to harvest data from the end-user 318 and/or computing device 302, the request may be met by the content server 308 with an anonymization policy. In this example, the content server 308 may be configured with additional policies that may be implemented to ensure that the end-user 318 only receives the information they care about, with no concern about threats, or privacy violations. In general, the implementation shown in FIG. 3 is of the content server 308 in the active protection mode.

In an example of operation, the content server 308 (in the active protection mode) transforms cookies (i.e., pieces of data sent from the second-party entities 338 and/or third-party entities 340) and selectively stores them in a specialized storage within the content server 308. The content server 308 transforms the cookies utilizing a transaction traversal technology that includes a JavaScript library 390 for processing content inside the end-user execution environment (i.e., the browser 320 on the computing device 302). The content server 308 is capable of intercepting and re-interpret corresponding functional calls inside an end-user JavaScript processing engine located within (or in association with) the browser 320. Consequently, upon receiving any content from the publisher 304 or computing device 302, the content server 308 ensures that such content is modified in order to enforce that all subsequent transactions will be handled by the content server 308 (on behalf of the publisher 304), and that the JavaScript library 390 (located on the computing device 302) is properly referenced and has access to all critical stages of generating requests to any third-party entities 340. A specially designed cookie-handling mechanism ensures that first-party (i.e., the publisher 304) cookies do not exceed the limits imposed by Internet standards on the size of a cookie belonging to a single domain.

In this example, the computing device 302 is in signal communication with the Internet 306 via signal path 354, the publisher 304 is in signal communication with the Internet 306 via signal path 356, and the content server 308 is in signal communication with the Internet 306 via signal path 358. As such, the signal path 350 between the computing device 302 and content server 308 includes the Internet 306 and the signal paths 354 and 358 and the signal path 352 between the publisher 304 and content server 308 includes the Internet 306 and the signal paths 352 and 358.

Specifically, in an example of operation, the end-user 318 utilizes the webpage 334 to provide the publisher 304 with the end-user data 360 that is sent from the browser 320, running on the computing device 302, to the publisher 304 via the content server 308 and signal paths 350 and 352 instead of the direct signal path 330 from the computing device 302 to the publisher 304. In this example, the content server 308 be established as uniform resource locator (“URL”) redirect of the Internet address of the website 328 of the publisher 304. As such, when the end-user 318 enters the Internet address of the website 328 of the publisher 304 in the address line 326 of the browser 320 of the computing device 302, the browser 320 is directed to the Internet address of the content server 308 instead of the publisher 304. As a result, the content server 308 receives the end-user data 360 instead of the publisher 304. In this example, the content server 308 is in the active protection mode and acts as active protection system for the end-user 318 at the computing device 302, publisher 304, or both because the content server 308 will connect directly to second-party entities 338, third-party entities 340, or both instead of the computing device 302 or publisher 304. As an example, the content server 308 may be in signal communication with the second-party entities 338 via a signal path 362 that is a combined signal path that includes the signal path 358 from the content server 308 to the Internet 306, the Internet 306, and a signal path 364 from the Internet 306 to the second-party entities 338. Similarly, the content server 308 may be in signal communication with a first third-party entity 366 via a signal path 368 that is a combination signal path that includes the signal path 358 from the content server 308 to the Internet 306, the Internet 306, and a signal path 370 from the Internet 306 to the first third-party entity 366. The content server 308 may also be in signal communication with a second third-party entity 372 via a signal path 374 that is a combination signal path that includes the signal path 358 from the content server 308 to the Internet 306, the Internet 306, and a signal path 376 from the Internet 306 to the second third-party entities 372. Furthermore, the content server 308 may also be in signal communication with a third third-party entity 378 via a signal path 380 that is a combination signal path that includes the signal path 358 from the content server 308 to the Internet 306, the Internet 306, and a signal path 382 from the Internet 306 to the third third-party entities 378.

In general, the browser 320 on the computing device 302 connects to the content server 308 and requests some service, such as a file, connection, media, webpage 328 hosted by the publisher 304, or other resource from the publisher 304 and the content server 308 in the active protection mode then evaluates the request and connects to the publisher 304 to retrieve the requested information for the browser 320 in this manner the content server 308 actively protects from threats, and ensures that the end-user data 360 of the end-user 318 is protected at all times. The request is forwarded on to the publisher 304, with all of the interaction between the publisher 304 and the third-party entities 340 controlled by the content server 308. In this example, as discussed earlier, the third-party entities 340 may include a plurality of third-party entities divided up into multiple tiers of third-party entities that may be chained together into different combinations. Similar to the publisher 304, each third-party entity of the third-party entities 340 may include one or more relationships to other third-party entities where there is no limit to the number and combinations of relationships that may exist between the third-party entities 340. In this example, the content server 308 is configured to detect and potentially stop and/or modify the end-user data 360 for any subsequent redirects from a first third-party entity to another third-party entity of the plurality of third-party entities 340.

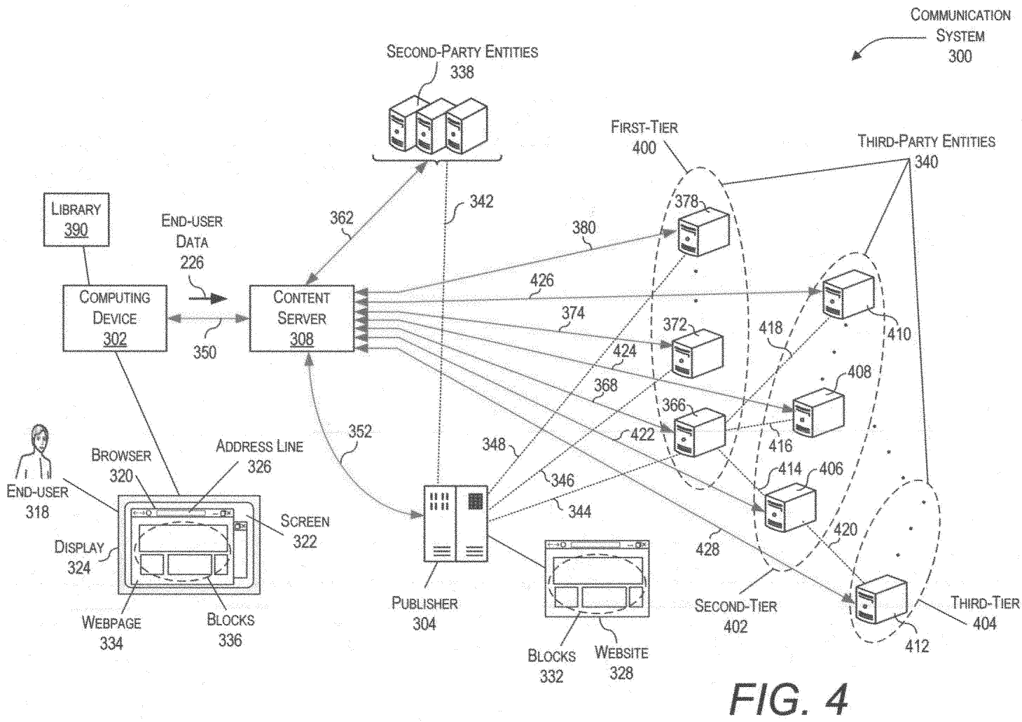

Turning to FIG. 4, a system block diagram of an example of the communication system 300 between the computing device 302, publisher 304, and multiple tiers of the third-party entities 340 is shown in accordance with the present disclosure. In FIG. 4, the Internet 306 is not shown for the purposes on ease of illustration, but it is appreciated by those of ordinary skill in the art that Internet 306 is present between the signal paths of the computing device 302, content server 308, publisher 304, second-party entities 338, and third-party entities 340 as shown in FIG. 3. For simplicity, only the combinational signal paths 350, 352, 362, 368, 374, and 380 are shown. Also shown in FIG. 4 are the relationships between the publisher 304 and the second-party entities 338 and the third-party entities 340 as the dotted-line paths 342, 344, 346, and 348, respectively.

In this example, the third-party entities 340 are shown to have multiple tiers that include, for example, a first-tier 400, second-tier 402, and third-tier 404 of third-party entities 340. It is appreciated that while only three tiers are shown there may be optionally an unlimited number of tiers of third-party entities 340 arranged in varying combinations. In this example, the first-tier 400 is shown to include the first third-party entity 366, second third-party entity 372, and the third-party entity 378; however, it is appreciated that the first-tier 400 may include any number of third-party entities of the plurality of third-party entities 340. Moreover, in this example, the second-tier 402 is shown as having a first third-party entity 406, second third-party entity 408, and third third-party entity 410. Again, only three third-party entities 406, 408, and 410 are shown for ease of illustration. Furthermore, the third-tier 404 is shown with only a signal third-party entity 412 but it is again appreciated that the third-tier 404 may include any number of third-party entities form the plurality of third-party entities 340.

In this example, the first third-party entity 366 of the first-tier 400 has relationships with the first third-party entity 406, second third-party entity 408, and third third-party entity 410 of the second-tier 402 via dotted-line paths 414, 416, and 418, respectively. Likewise, the first third-party entity 406 has a relationship with the third-party entity 412 via dotted-line path 420. As a result, the content server 308 is in signal communication with the first third-party entity 406, second third-party entity 408, and third third-party entity 410 of the second-tier 402 and third-party entity 412 of the third-tier 404 via signal paths 422, 424, 426, and 428, respectively.

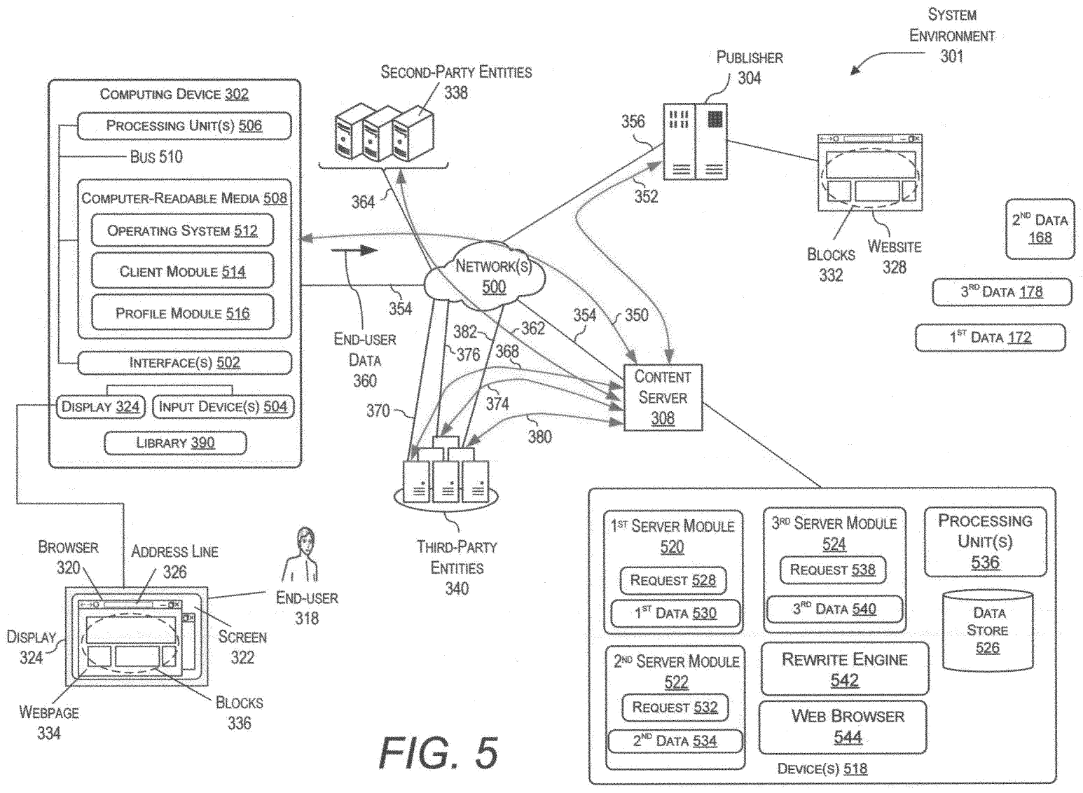

In FIG. 5, a system diagram is shown illustrating an example of another implementation of the system environment 301 where the content server 308 manages data in accordance with the present disclosure. The system environment 301 includes the content server 308 (which is a proxy server) having one or more servers that acts as an intermediary between the end-user 318, the publisher 304, and the plurality of third-party entities 340.

In this example, the content server 308, publisher 304, second-party entities 338, third-party entities 340, and computing device 302 are in signal communication with one or more telecommunication networks 500 via signal paths 354, 356, 364, 370, 376, and 382, respectively. In this example, the one or more telecommunication networks 500 may include, for example, public networks such as the Internet (as was described previously as Internet 306), private networks such as an institutional and/or personal intranet, or some combination of private and public networks.

The one or more telecommunication networks 500 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. The one or more telecommunication networks 500 may utilize communications protocols, including packet-based and/or datagram-based protocols such as IP, transmission control protocol (“TCP”), user datagram protocol (“UDP”), or other types of protocols. Moreover, the one or more telecommunication networks 500 may also include a number of devices that facilitate network communications and/or form a hardware basis for the networks, such as switches, routers, gateways, access points, firewalls, base stations, repeaters, backbone devices, and the like.

In some examples, the one or more telecommunication networks 500 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

As before, in this example, the content server 308 is shown in signal communication with both the publishers 304 and the computing device 302 via signal paths 352 and 350, respectively. Moreover, the content server 308 is also in signal communication with the plurality of third-party entities 340 via a signal paths 368, 374, and 380.

In this example, the computing device 302 may be a computer 310, portable computer 312, server 316, mobile device 314 (such as a smart telephone, tablet, etc.), videogame console, etc. In general, the computing device 302 may include one or more computing devices that operate in a cluster or other grouped configuration to share resources, balance load, increase performance, provide fail-over support or redundancy, or for other purposes. For instance, the computing device 302 may belong to a variety of classes of devices such as traditional server-type devices, desktop computer-type devices, and/or mobile-type devices.

In some implementations, the computing device 302 includes one or more input/output (“I/O”) interfaces 502 that enable communications with input/output devices such as user input devices 504 including peripheral input devices (e.g., a game controller, a keyboard, a mouse, a pen, a voice input device, a touch input device, a gestural input device, and the like) and/or output devices including peripheral output devices (e.g., a display 324, a printer, audio speakers, a haptic output device, and the like). The computing device 302 may also include a combination of two or more devices, such as a mobile phone in combination with a wearable device.

The computing device 302 may represent any type of computing device having one or more processing units 506 in signal communication to a computer-readable media 508 via a bus 510, which in some instances may include one or more of a system bus, a data bus, an address bus, a PCI bus, a Mini-PCI bus, and any variety of local, peripheral, and/or independent buses. Executable instructions stored on the computer-readable media 508 can include, for example, an operating system 512, a client communication module 514, a profile module 516, and other modules, programs, or applications that are loadable and executable by the one or more processing units 506.

The computing device 302 can also include the one or more interface(s) 502 to enable communications between the computing device 302 and other networked devices, such as the content server 308. The network interface(s) 502 can include one or more network interface controllers (“NICs”) or other types of transceiver devices to send and receive communications and/or data over the one or more networks 500. In this example, the computing device 302 also includes the JavaScript library 390.

In this example of the system environment 301, the computing device 302 utilizes its client communication module 514 to connect with the client server 308 and/or other external device(s) through the one or more telecommunication networks 500. In various examples, the computing device 302 utilizes its profile module 516 to generate user profiles for communicating with other devices (such as content server 308) over the one or more telecommunication networks 500. In general, a user profile may include one or more of an identity of a user (e.g., a name, a unique identifier (“ID”), etc.), a user avatar, personal data (e.g., age, title, position, etc.), location data, status data (e.g., online, offline, available, busy, etc.) and so forth.

The content server 308 may be any device, network, or system that can communicate with and act as a proxy intermediary between the end-user 318, the publishers 308, second-party entities 338, and third-party entities 340 in accordance with one or more features of the present disclosure. For example, the content server 308 may be in the form of a cloud proxy or cloud network made up of one or more servers.

In this example, the end-user 318 is an individual but may also be an automated device of software component of module capable of interfacing with the computing device 302 to search the one of more telecommunication networks 500. As an example, the computing device 302 may also include the browser 320, which is a software application (i.e., program) for browsing (i.e., searching and viewing information) the Internet, where the software application is stored on a memory unit within the computing device 302. At present, examples of known browsers 320 include, for example, Google Chrome® produced by Google LLC. of Mountain View, Calif., Mozilla Firefox® produced by Mozilla Foundation of Mountain View, Calif., Safari® produced by Apple, Inc. of Cupertino, Calif., and Internet Explorer® and Edge® produced by Microsoft Corporation of Redmond, Wash. The executable instructions of the browser 320 are loaded in the computer-readable media 508 for execution by the one or more processing units 506 of the computing device 302. In general, the computer-readable media 508 is a computer or machine-readable medium that is a medium capable of storing data in a format readable by a computer and/or mechanical device rather than human readable.

The browser 320 may display information to the end-user 318 on the display 324 of the computing device 302, which may be, for example, a screen 322 on a computer, television, or hand-held device. The displayed information on the display 324 may contain the one or more blocks 336 of content, which may include a publisher block that visually displays Internet content created by the publisher 304, the second-party entities 338, and third-party entities 340.

The content server 308 acts as a proxy intermediary between the computing device 302 and the second-party entities and/or third-party entities 340 and applies multiple network and content optimization techniques to achieve reduced latency and improved efficiency while controlling any delivered and shared information with the end-user 318.

In this disclosure, the content server 308 operates differently than convention Internet interactions to help improve the end-user 318 experience.

Specifically, in a conventional system as described earlier, the publisher 304 would communicate directly with the computing device 302 and the computing device 302 would resolve the domain name of the publisher 304 and connect directly to the website 328 of a web server of the publisher 304. The publisher 304 would prepare the Internet content and directly push that content to the computing device 302 where the Internet content is rendered for delivery to the end-user 318, via the webpage 334 that is a browser window of the browser 320 or the like, to be displayed in a block 336 on the display 324 either within the browser window or separate window displayed on the display 324.

In the convention system, the rendered content also contains Internet hyperlink references to at least one third-party entity of the plurality of third-party entities 340 that allows the at least one third-party to directly deliver scripts, documents, or advertisements to the computing device 302, where these scripts, documents, or advertisements are executed along with the Internet content provided by the publisher 304. In contrast, the content server 308 in the active protection mode does not allow the publisher 304, second-party entities 338, or third-party entities 340 to communicate directly with the computing device 302. Instead, the publisher 304, second-party entities 338, and third-party entities 340 communicate indirectly with the computing device 302 through the content server 308 that acts as a proxy intermediary.

The content server 308 includes one or more devices 518. The one or more devices 518 and/or components of the content server 308 can include distributed computing resources that communicate with one another and/or with the computing device 302, the publisher 304, second-party entities 338 and the third-party entities 340 via the one or more telecommunication networks 500.

In various examples, the one or more devices 518 may operate in a cluster or other grouped configuration to share resources, balance load, increase performance, provide fail-over support or redundancy, or for other purposes. As an example, the one or more devices 518 of the content server 308 includes a first server module 520, second server module 522, third server module 524, and a data storage 526.

As an example, the first server module 520 is configured to receive, from the end-user 318 (utilizing the computer device 302) a domain name resolution request for the publisher 304. Typically, the end-user 318 will use a search engine link or type in a domain name with the input device 504 for the publisher 304 rather than using an IP address. The domain name is converted to the IP address via a procedure called domain name service (“DNS”) resolution or DNS lookup in conventional fashion.

As described earlier, in this example, the publisher 304 will have its IP address associated with the content server 308 such that when the computing device 302 attempts to contact the publisher 304, the computing device 302 will receive the IP address for the contact server 308 instead of an IP address for the publisher 304. The computing device 302 thus connects to the content server 308 and requests 528 an Internet first data 530 from the publisher 304. In this example, the first data 530 may be, for example, a webpage. The first server module 520 receives the request 528 for the first data 530 and, in response, the content server 308 makes a request 532 for first data 530 from the publisher 304. The publisher 304 receives the request 532 for the first data 530 and, in response, creates and sends the first data 530 to the second server module 522. The content server 308 then detects any redirects in the first data 530 from the 304. If there is any redirects in the first data 530, the content server 308 modifies the redirects in the first data 530 to produce the second data 534 by, for example, rewriting the first data 530 to remove the redirects with one or more processing units 536 within the content server 308. The third server module 524 then requests 538 information data from a third-party entity (of the third-party entities 340) that the redirect was directed to. If any information from the end-user 318 needs to be passed to the third-party entity, the content server 308 may cleanse and anonymize the end-user data 360 (e.g., to produce a cleansed user data) prior to sending to the third-party entity. The third-server module 524 then receives the information from the third-party entity and combines it with the second data 534 to produce a third data 540. The content server 308 then transmits the third data 540 to the computing device 302.

The content server 308 may utilizes the flow of information to create a server-side browser-like environment. The browser-like environment is used to execute the modified Internet content including excised and/or rewritten redirect link blocks or scripts. The blocks or scripts of the redirects are thus getting executed as if they were on the computing device 302, while in a simulated browser-like environment that mimics the browser 320 of the computing device 302 with improved fidelity.

As an example, the communication with the third-party entity and the rewriting of the data is achieved by a server-side browser (i.e., at the content server 308) shadowing environment and/or end user-side (i.e., at the computing device 302) instrumentation. This approach may utilize Javascript and rewriting uniform resource locators (“URLs”) in Javascript in a corporate environment, where these functions may be implemented within a clientless or browser-based secure sockets layer (“SSL”) virtual private network (“VPN”) gateways providing secure remote access to internal resources. In general, URL rewriting allows a URL to be separated from a resource such that the URL and the resource that it leads to can be independent of each other. In this disclosure, URL rewriting (also known as URL manipulation) allows the end-user 318 utilizing the computing device 302 to link to a URL of the publisher 304 that has been rewritten to direct the link to the original URL to a new URL at the content server 308 in a way that is transparent to the computing device 302 and end-user 318. In general, URL rewriting is a process of altering (often automatically by means of a software program) the parameters in a URL. It is a way of implementing URL mapping or routing within a Web app. The Web app is a client-server computer program that the client (i.e., the computing device 302) runs in the browser 320. In this example, a software program that automatically performs URL rewriting is generally known as rewrite engine. In this example, the one or more devices 518 of the content server 308 is shown also including a rewrite engine 542 module that is associated with a web browser application 544 on the content server 308, where the rewrite engine 542 may be a component of the web browser application 544 or a web application framework (also known as a web framework). The web framework is a software framework that is designed to support the development of web applications that include, for example, web services, web resources (i.e., a resource located on the one or more telecommunication networks 500), and web application programming interfaces (“APIs”).

In all of these examples, the one or more devices 518 of the content server 308 may also include the data storage 526 such as, for example, a memory unit to store any needed information related the first data 530, second data 534, or third data 540.

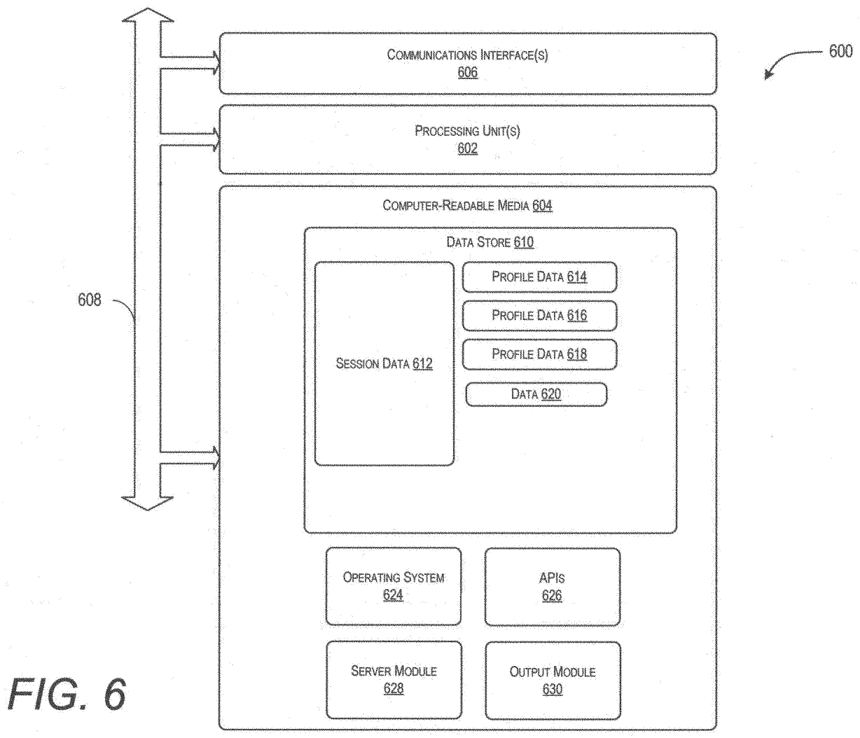

In FIG. 6, a system diagram of an example of an implementation of components of a device 600, such as a device of the one or more devices 518, is shown configured to receive requests from the computing device 302, send requests for data from the publisher 304 and third-party entities 340, receiving data from the publisher 304 and third-party entities 340, and sending the data to the computing device 302, respectively.

In this example, the device 600 includes one or more processing unit(s) 602, computer-readable media 604, and/or communication interface(s) 606. The components of the device 600 are in signal communication and operatively connected, for example, via a bus 608, which can include one or more of a system bus, a data bus, an address bus, a PCI bus, a Mini-PCI bus, and any variety of local, peripheral, and/or independent buses.

As utilized herein, the processing unit(s) may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized in this disclosure, a computer-readable media, such as computer-readable media 604 and/or computer-readable media 508, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 606 may represent, for example, network interface controllers (“NICs”) or other types of transceiver devices to send and receive communications over a network.

The computer-readable media 604 can include the data store 610. In some examples, the data store 610 includes data storage such as a database, data warehouse, or other type of structured or unstructured data storage. In some examples, the data store 610 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 610 can store data for the operations of processes, applications, components, and/or modules stored in computer-readable media 604 and/or executed by processing unit(s) 602 and/or accelerator(s). For instance, in some examples, the data store 610 can store session data 612 (between the computing device 302 and the publisher 304), profile data 614 for the computing device 302, profile data 616 for the publisher 304, profile data 618 for the third-party entities 340, requests, data 620 (such as, for example, first data 530, second data 534, and third data 540), and/or other data. The computer-readable media 604 can also include operating system 624 and APIs 626 configured to expose the functionality and the data of the device 600 to external devices associated with content server 308. Additionally, the computer-readable media 604 includes one or more server modules 628 and one or more output modules 630. In this example, the data store 610 may be part of the data store 526 shown in FIG. 5.

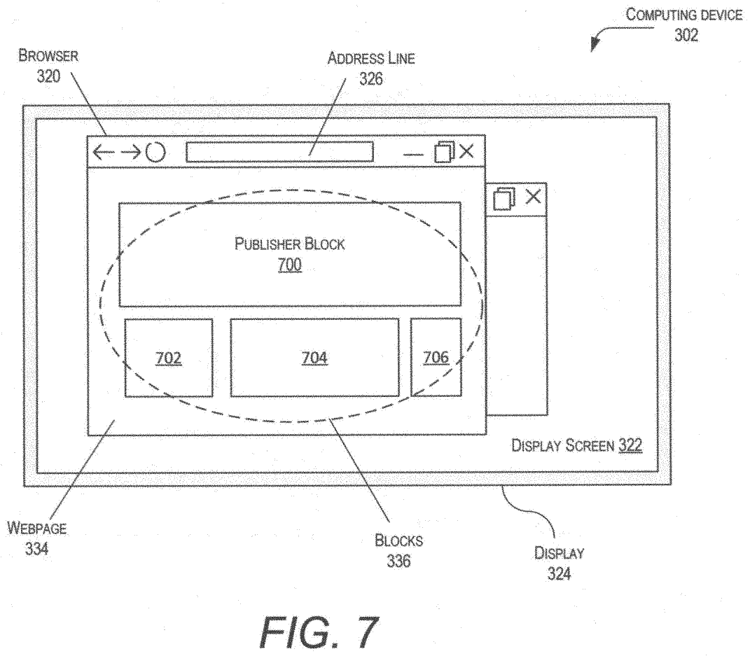

Turning to FIG. 7, a system diagram of an example of an implementation of the display 302 of the computing device 302 in accordance with the present disclosure. In this example, the display 324 includes the display screen 322. As described earlier, the computing device 302 may run a web browser 320 that displays a browser window that displays the webpage 334 on the display screen 322. As described earlier, the browser 320 may display information to the end-user 318 on the display screen 322, which may be information that includes the one or more blocks of content 336, which may include a publisher block 700 that visually displays Internet content created by the website 328 of the publisher 304 and one or more blocks 702, 704, and 706 that display publisher 304 related content, such as an advertisement, financial information (such as, for example, stock prices, equity fund information, pension fund information, banking information, etc.), mapping information and applications (such as, for example, geographic information systems (“GIS”) such as Mapquest, Google maps, Apple Maps, etc.), business information analytics, etc., or other information that may be of interest to the end-user 318, created by or delivered by one or more third-party entities of the plurality of third-party entities 340.

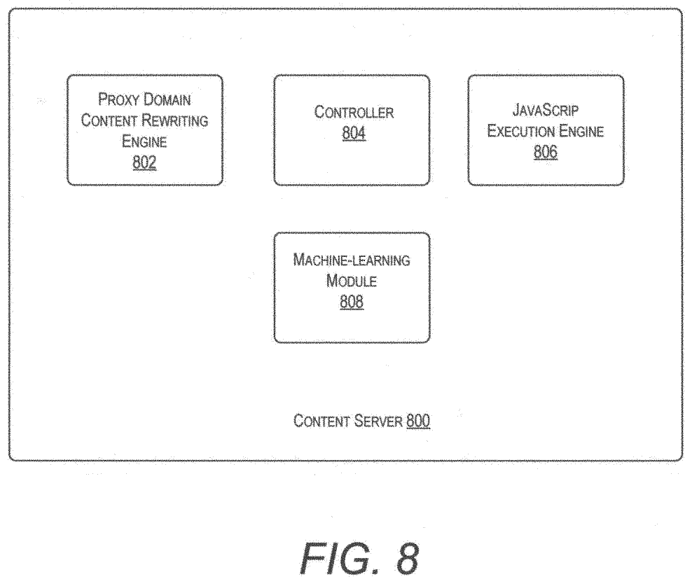

Turning to FIG. 8, a system block diagram of an example of another implementation of a content server 800 in accordance with the present disclosure. In this example, the content server 800 also includes one or more modules, such as a proxy domain content rewriting engine 802, a controller 804, a JavaScript execution engine 806, and a machine-learning module 808.

The JavaScript execution engine 806 performs some or all tasks of executing JavaScript rather than having them all performed by the computing device 302, thus reducing processing and content access time to improve the performance of the computing device 302 and corresponding experience of the end-user 318. The JavaScript execution engine 806 may also simultaneously perform activities such as interactions with the third-party servers of the third-party entities 340. The machine learning module 808 may be used to reduce the risk of errors in content rewriting and to predict interactions with third-party entities 340 without the need to execute all scripts on the computing device 302. Additional similar modules could also be employed within the content server 800.

Again, the content server 800 is a proxy server that acts as an intermediary for requests from clients (i.e., the computing device 302) seeking resources from other servers (i.e., the publisher 304). Specifically, the content server 800 intercepts the request from the browser 320 and acts on behalf of the publisher 304 in a manner that may be transparent to the computing device 302, browser 320, and end-user 318.

In this example, the proxy domain content rewriting engine 802 is a request/response processor and utilizes either the same domain as the original content or a special sub-domain for delivery of all advertising-related information. The proxy domain content rewriting engine 802 is resolved to the content server 800 to ensure privacy and security controls.

As an example, the content server 800 may replace all the links to the third-party entities 340 to point to a proxy domain and create a unique cookie/supercookie (“UC”) for tracking purposes. In this example, the content server 800 aliases the UC to all third-party trackers and the content server 800, where necessary, provides a JavaScript pass-through for third party domains but executes them on behalf of the third-party domains. The content server 800 can use a JavaScript execution module (such as JavaScript execution engine 806) to minimize the repeated execution of the same/similar automatically or manually defined script fragments for the given publisher 304.

In this example, the controller 804 is a cloud-based policy enforcement engine that can control the exchanges of information between the computing device 302, the publisher 304, and the third-party entities 340. Per the publisher 104 configuration and/or per the computing device 302 configuration, the controller 804 maintains and enforces tracking and data exchange policies. The controller 804 manages publisher-defined allow/block preferences for third-party trackers of the third-party entities 340. The controller 804 also manages end user-defined allow/block preferences for third-party trackers. For ease of the preference management of the end-user 318, the controller 804 provides for default profiles typically derived from the publisher 304 preferences. In addition, the content server 800 implements various techniques for reducing latency and improving bandwidth utilization. For example, the content server 800 may implement compression technologies, transmission control protocol (“TCP”) optimization, caching, and the like. In this example, the controller 804 may include the computing device 302 or simply the one or more processing units 506, computer-readable media 508, and one or more interfaces 502.

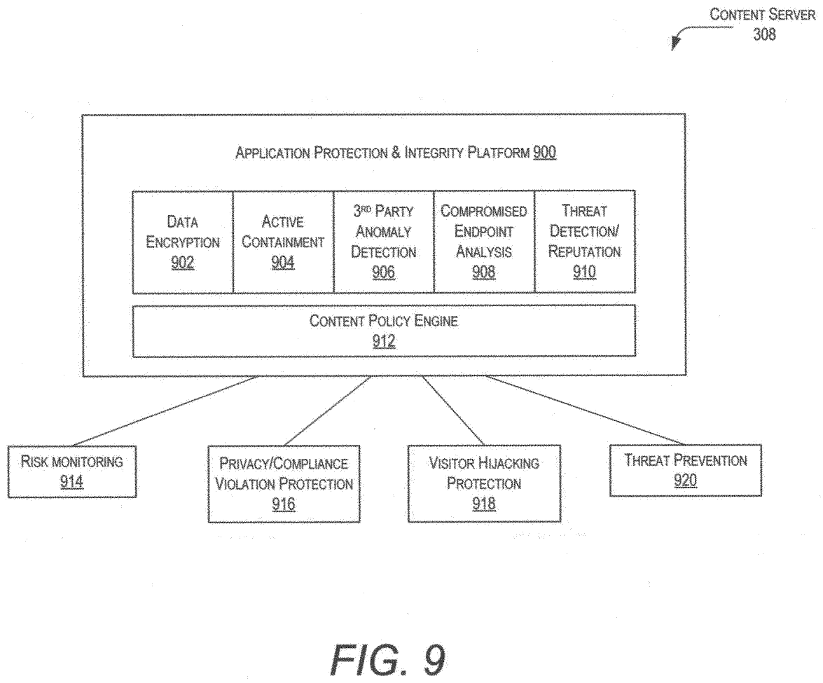

Turning to FIG. 9, a block diagram illustrating the elements of the content server 308 is shown in accordance with the present disclosure. The content server 308 is shown acting as a security platform having an application protection and integrity platform 900 that includes a selective data encryption element 902, active containment element 904, third-party anomaly detection element 906, compromised endpoint analysis element 908, threat detection and reputation element 910, and content policy engine 912. In this example, the application protection and integrity platform 900 performs the functions of risk monitoring 914, privacy and/or compliance violation protection 916, visitor hacking protection 918, and threat prevention 920.

In this example, the selective data encryption element 902 allows customers (i.e., the publisher 304) to create policies that selectively encrypt data before delivery to third-party applications at the third-party entities 340. While some data must remain unencrypted for many of these applications to perform their desired functions, data that violates privacy policies, compliance requirements, or is sensitive can be encrypted transparently, in real-time. The active containment element 904 ensures that active web content is contained when being delivered to the browser 320 of the end-user 318. It is appreciated by those of ordinary skill in the art that many cross-site scripting (“XSS”), or “drive-by” attacks utilize active web content like Javascript to invoke malicious functions on the computing device 302 of the end-user 318, compromising computing device 302 without the knowledge of the end-user 318. The active containment element 904 is a software/hardware module that rewrites active content within an iframe so that any attempt to compromise the endpoint (i.e., the computing device 302) is contained within a “sandbox,” all transparently to the third-party provider, without affecting the experience of the end-user 318.

The third-party anomaly detection element 906 provides inspection of the content being delivered both to the computing device 302 of the end-user 318 and the third-party providers of the plurality of third-party entities 340, detecting when content differs from what is expected. Policies can be created to inspect content for specific terms important to the publisher 304—including competitor names, offensive content or other sensitive content types. Once identified, the content server 308 can redact content without affecting the experience of the end-user 318.

The comprised endpoint analysis element 908 is configured to detect anomalies with the second-party entities 338 and/or third-party entities 340. If the endpoint (i.e., the computing device 302) is protected by an anti-virus or anti-malware software (such as, for example, McAfee or Symantec), the comprised endpoint analysis element 908 is able detect anomalies by comparing the list of requests between the content server 308 generated reports and the reports of the client (i.e., the computing device 302), thus allowing content server 308 to immediately take action against malicious software on the client side. The threat detection and/or reputation element 910 provides real-time protection from third-party applications of the plurality of third-party entities 340. The threats may include malicious images (“malvertising”), to active content that is intending to act maliciously. Also, the content server 308 compares third-party IP addresses and domains against a list of known threat sources to protect the website 328 and/or Web app of the publisher 304 from malicious activities.

The content policy engine 912 provides inspection of content being delivered both to the computing device 302 of the end user 318 and the third-party providers of the third-party entities 340, detecting when content differs from what is expected. Policies can be created to inspect content for specific terms important to the publisher 304—including competitor names, offensive content or other sensitive content types. Once identified, the content policy engine 912 is configured to redact content without affecting the experience of the end-user 318 or apply other remediation measures.

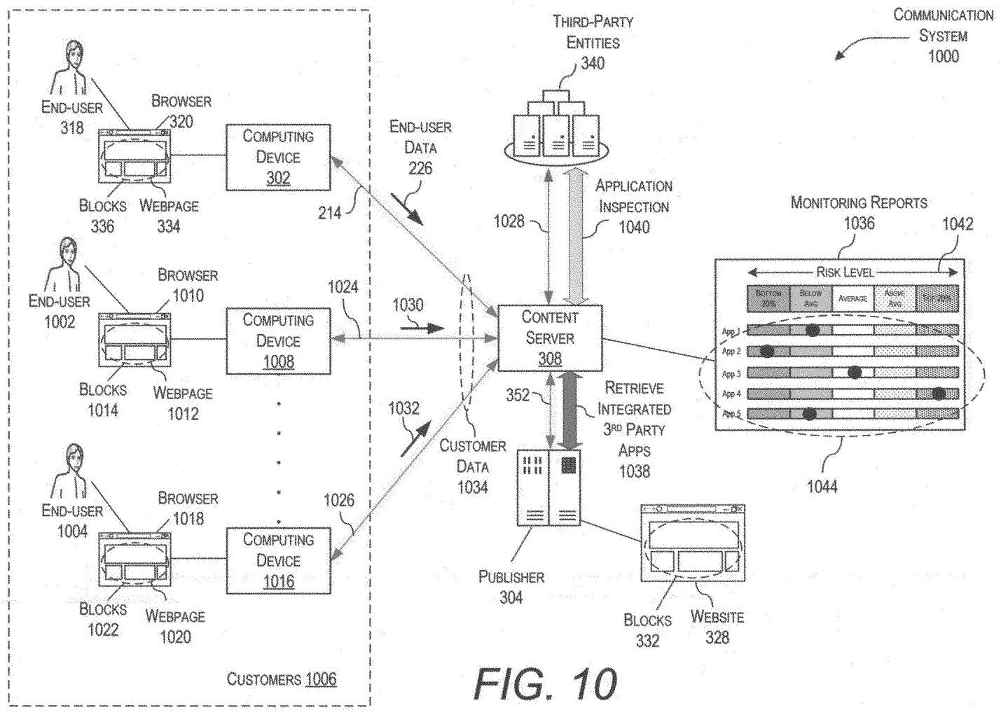

In FIG. 10, a communication system 1000 is shown for risk monitoring with the content server 308 in accordance with the present disclosure. In this example, multiple end-users 318, 1002, and 1004 are shown as customers 1006 of the publisher 304. Similar to the first end-user 318, the second end-user 1002 also utilizes a second computing device 1008 having a second browser 1010 that displays a second webpage 1012 with blocks 1014 of data. Likewise, the third end-user 1004 also utilizes a third computing device 1016 having a third browser 1018 that displays a third webpage 1020 with blocks 1022 of data. It is appreciated that only three end-users 318, 1002, and 1004 are shown for ease of illustration and that there may many more end-users than just three.

In this example, the content server 308 is in signal communication with the first computing device 302, second computing device 1008, and third computing device 1016 via signal paths 214, 1024 and 1026, respectively. The content server 308 is also in signal communication with the publisher 304 via the combined signal path 352 and the plurality of third-party entities 340 via a combination 1028 of signal paths that include 368, 374, 380, 422, 424, 426, and 428 (shown in FIG. 3-5). The computing devices 302, 1008, and 1016 provide end-user data 238, 1030, and 1032 to the content server 308 via signal paths 214, 1024, and 1026, respectively. The combined end-user data 238, 1030, and 1032 is referred to as the customer data 1034.

In this example, the content server 308 is operating in the monitoring mode. In this mode, the content server 308 acts as a sentinel platform that remotely monitors the third-party applications of the third-party entities 340 and provides monitoring reports 1036 on each third-party entity of the plurality of third-party entities 340 that linked to by the publisher 304. The content server 308 can remotely retrieve the third-party application from the website 328 or Web app of the publisher 304 directly by inspecting the “tags” embedded in the website 328 (of the publisher 304) itself. An additional option of integrating with the website 328 and/or Web application's Tag Manager is available, which can provide a more comprehensive list of integrated third-parties entities of the plurality of third-party entities 340.

As such, the content server 308 allows the content server 308 to take back control of the customer data 1034 and protect from third-party entity access to any sensitive data. The content server 308 provides high-speed processing of traffic between the publisher 304 application and/or website 328 visitors (i.e., end-users 318, 1002, and 1004) and third-party application providers (of the third-party entities 340), with the ability to apply policies and rewrite data on the fly to apply multiple protection schemes. Each session is processed independently, and transparently to the end-user 318, 1002, or 1004, ensuring the experience is unchanged from the expected application and/or web site 328 behavior.

In this example, the content server 308 retrieves 1038 integrated third-party applications (from the third-party entities 340) and then inspects 1040 the third-party applications. The content server 308 then produces the monitoring reports 1036 that include third-party entity security posture and/or reputation, third-party entity geo-location, and additional third-party entity redirects. Each of these reports may include a risk level 1042 (for example, from bottom 20%, below average, average, above average, and top 20%) for a plurality of third-party applications 1044 (for example, App 1, App 2, App 3, App 4, and App 5) showing the corresponding risk for each third-party application 1044. From the monitoring reports 1036, administrators of the publisher 304 are better equipped to make decisions on whether to remove or replace individual third-party applications 1044 from the plurality of third-party entities 340.

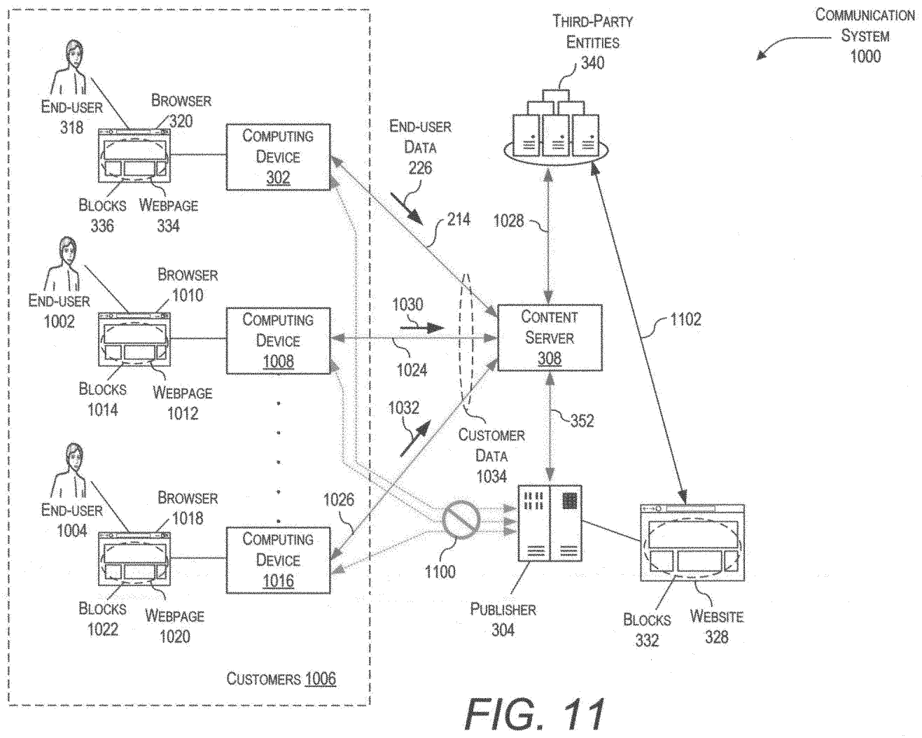

In FIG. 11, the communication system 1000 is shown for active containment with content server 308 in accordance with the present disclosure. In this example, the content server 308 is configured to provide privacy and compliance protection by ensuring that active website 328 content for the customer data 1034 is contained when being delivered to the endpoint browser (i.e., browser 320, 1010, or 1018). The customer data 1034 is prevented 1100 from being directly entered into website 328 and is first passed to the content server 308 which modifies the customer data 1034 before providing the modified customer data to the website 328 which is then passed to the third-party entities 340 via signal path 1102. In this mode of operation, the content server 308 may protect customer data 1034 by preventing, anonymizing, modifying the customer data 1034 before it is provided to the third-party entities 340. Examples of information in the customer data 1034 that may be protected includes, for example, email, name, company information, financial information, or other sensitive information. In addition to these example, the content server 308 may prevent third-party entities 340 that are outside a permitted geo-location from receiving or sending data from the customers 1006. As such, the content server 308 can identify and protect customer data 1034 being harvested by the third-party entities 340, identify and protect from restricted geo-located third-party entities 340, and protect from potential compliance violations such as, for example, GDPR, PCI, HIPAA, SOX, etc.

As discussed earlier, many cross-site scripting (“XSS”), or “drive-by” attacks utilize active web content like JavaScript to invoke malicious functions on the remote endpoints (i.e., computing devices 302, 1008, and 1016) of the customers 1006, compromising the computing devices 302, 1008, and 1016 without the knowledge of the end-users 318, 1002, and 1004. The content server 308 operating in the active containment mode safeguards all active content so that any attempt to compromise the publisher 304 is protected by a “sandbox,” all this transparent to the third-party provider of the third-party entities 340, without affecting the experience of the end-users 318, 1002, and 1004.

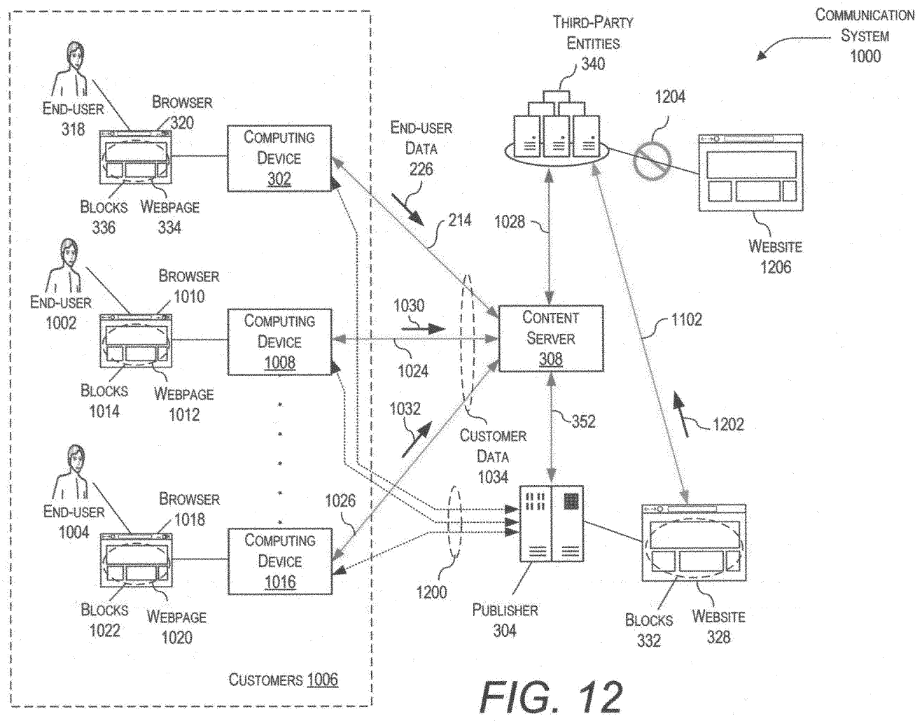

FIG. 12 is a block diagram of the communication system 1000 for anomaly detection with the content server 308 in accordance with the present disclosure. In this example, the content server 308 provides inspection of content 1200 and 1202 being delivered both to the computing devices 302, 1008, and 1016 of the end-users 318, 1002, and 1004 and the third-party providers of the third-party entities 340, detecting when the content 1200 and 1202 differs from what is expected.

The content server 308 is configured to utilize policies (established by the publisher 304 or content server 308) that can be created to inspect the content 1200 and 1202 for specific terms important to the publisher 304—including competitor names, offensive content or other sensitive content types. Once identified, the content server 308 can redact content 1200 and 1202 without affecting the experience of the end-users 318, 1002, and 1004. As an example, by utilizing anomaly detection, the content server 308 may prevent 1204 potential customer 1006 hijacks from a website 1206 of a competitors. Moreover, the content server 308 can identify tracking applications and/or advertising plug-ins of competitors, remove third-party redirection from the website 328 of the publisher 304 by competitors, and preserve the customers 1006 on the website 328 or Web app of the publisher 304.

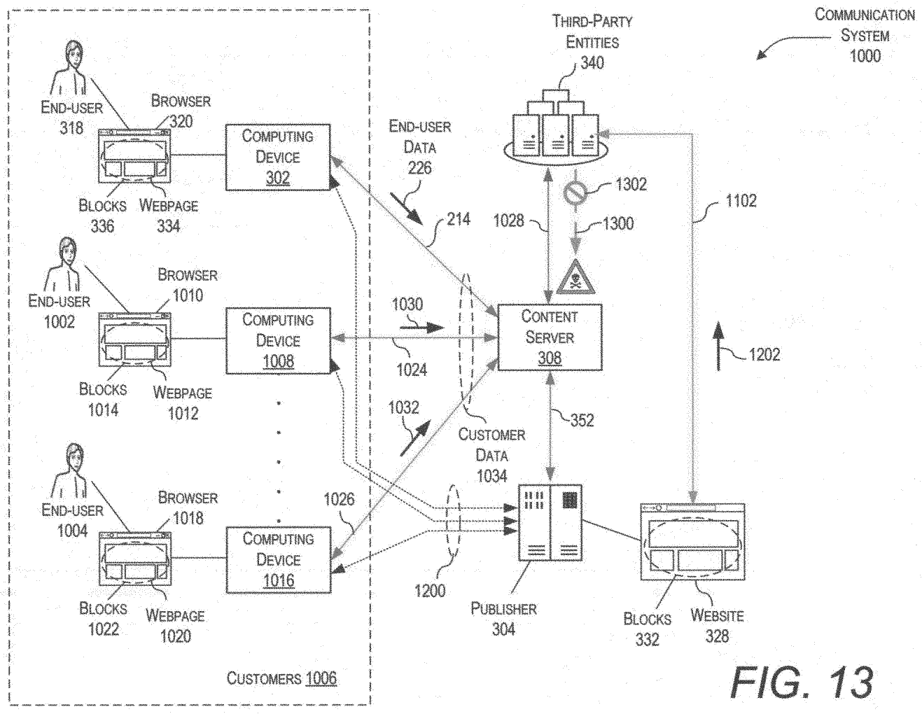

Turning to FIG. 13, a block diagram of the communication system 1000 for threat detection and/or reputation determination with the content server 308 is shown in accordance with the present disclosure. In this example, the content server 308 is configured to provide real-time protection from third-party applications from the third-party entities 340. In this example, threats can include malicious images (“malvertising”), to active content 1300 that is intending to act maliciously and is stopped 1302 by the content server 308. Also, the content server 308 is configured to compare third-party IP addresses and domains of third-party entities 340 against a list of known threat sources to block and protect the web site 328 and/or Web app of the publisher 304 from malicious activities of malware and ransomware.

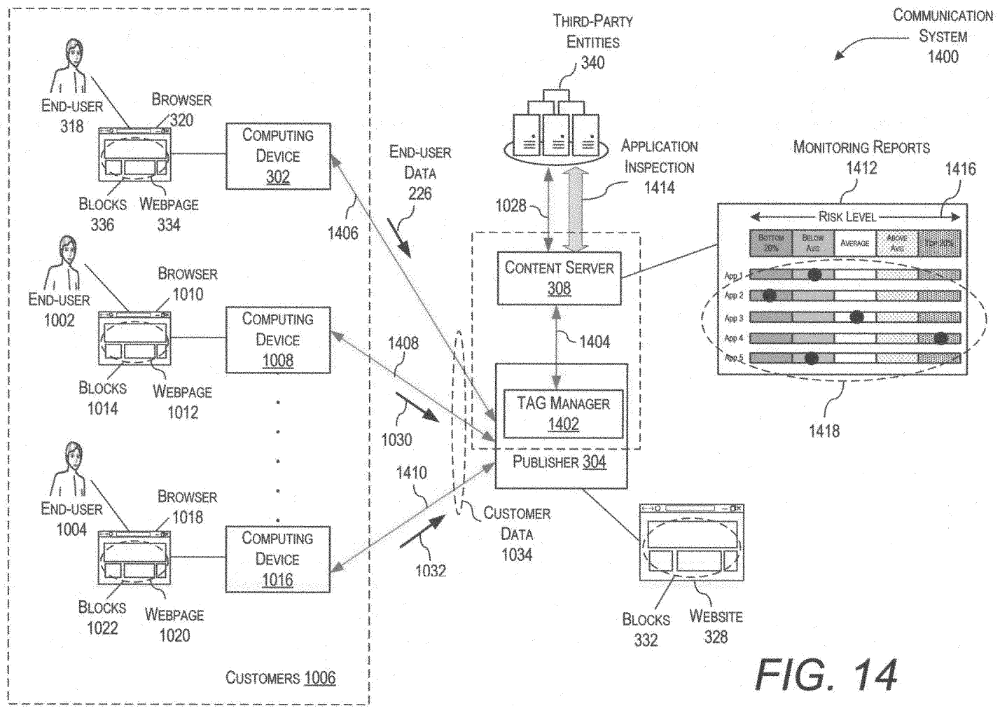

In FIG. 14, a communication system 1400 is shown for active out-of-band monitoring with the content server 308 in accordance with the present disclosure. Similar to the example described in relation to FIG. 10, in this example, the multiple end-users 318, 1002, and 1004 are shown as customers 1006 of the publisher 304.

In this example, the content server 308 is deployed in the same way as the monitoring mode shown in FIG. 10 except that in this example the content server 308 is integrated with a tag manager 1402 of the website 328 and/or Web app of the publisher 304 such that tag manager 1402 is in signal communication with the content server 308 via signal path 1404. The tag manager 1402 is in signal communication with the first computing device 302, second computing device 1008, and third computing device 1016 via signal paths 1406, 1408 and 1410, respectively. As before, the content server 308 is also in signal communication with the publisher 304 via the combined signal path 352 and the plurality of third-party entities 340 via a combination 1028 of signal paths that include 368, 374, 380, 422, 424, 426, and 428 (shown in FIG. 3-5). The computing devices 302, 1008, and 1016 provide end-user data 238, 1030, and 1032 to the tag manager 1402 via signal paths 1406, 1408, and 1410, respectively. The combined end-user data 238, 1030, and 1032 is referred to as the customer data 1034.

In this mode, the content server 308 via the TAG manager 1402 acts as a sentinel platform that remotely monitors the third-party applications of the third-party entities 340 and provides monitoring reports 1412 on each third-party entity of the plurality of third-party entities 340 that linked to by the publisher 304. As before, the content server 308 can remotely retrieve the third-party application from the website 328 or Web app of the publisher 304 directly by inspecting the “tags” embedded in the website 328 (of the publisher 304) itself. The content server 308 is integrated with the website 328 and/or Web application's Tag Manager 1402, which provides a more comprehensive list of integrated third-parties entities of the plurality of third-party entities 340 that was available in the example shown in FIG. 10. By utilizing active out-of-band monitoring, when third-parties entities 340 violate the policies of the content server 308, third-parties entities 340 can be dynamically removed from the Web site 328 and/or Web app to ensure the protection of customers' data, and threats are not introduced at the publisher 304.

In this example, the content server 308 retrieves integrated third-party applications (from the third-party entities 340) and then inspects 1414 the third-party applications. The content server 308 then produces the monitoring reports 1412 that include third-party entity security posture and/or reputation, third-party entity geo-location, and additional third-party entity redirects. Each of these reports may include a risk level 1416 (for example, from bottom 20%, below average, average, above average, and top 20%) for a plurality of third-party applications 1418 (for example, App 1, App 2, App 3, App 4, and App 5) showing the corresponding risk for each third-party applications 1044. From the monitoring reports 1412, administrators of the publisher 304 are better equipped to make decisions on whether to remove or replace individual third-party applications 1418 from the plurality of third-party entities 340.

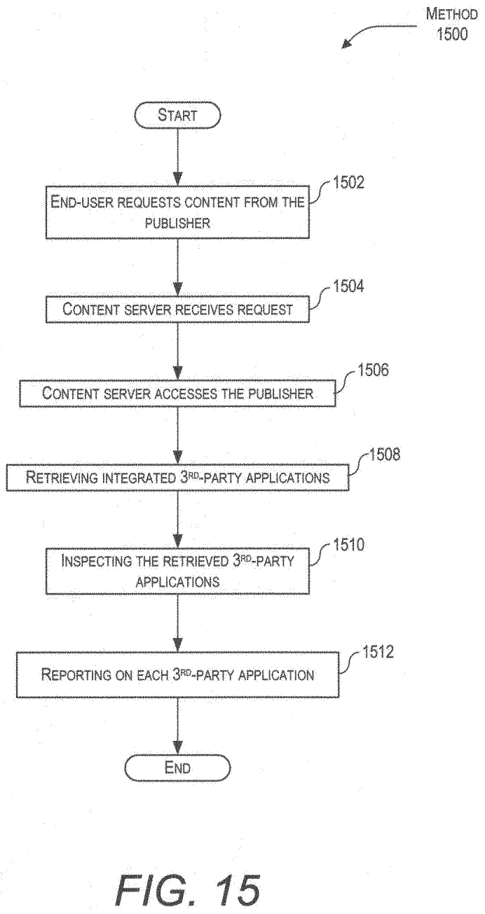

In FIG. 15, a flowchart of an example of an implementation of a method performed by the content server 308 is shown in accordance with the present disclosure. In this example, the content server 308 is operating in the monitoring mode as described in relation to FIG. 10. In this example, the process will be described in relation to the first end-user 318 and computing device 302 for ease of illustration but it is appreciated that the process would be the same for the other end-users 1002 and 1004 and computing devices 1008 and 1016.

The method 1500 starts by the end-user 318 requesting 1502 information content from the publisher 304 via the browser 320 on the computing device 302. The content server 308 receives 1504 the request from the computing device 302 because the content server 308 is acting as a proxy server for the publisher 304. The request from the computing device 302 may be part of the end-user data 238. The content server 308 is operating in the monitoring mode such that the content server 308 acts as a sentinel platform that remotely monitors the third-party applications of the third-party entities 340. In monitoring the third-party applications of the third-party entities 340, the content server 308 accesses 1506 the website 328 or Web app of the publisher 304 that the end-user 318 desires to access and retrieves 1508 (shown as 1038 in FIG. 10) any integrated third-party applications from the third-party entities 340 that are linked to the website 328 or Web app. The content server 308 then inspects 1510 (shown as 1040 in FIG. 10) the retrieved third-party applications and produces 1512 a monitoring report on each third-party entity of the plurality of third-party entities 340 that is linked to the website 328 or Web app of the publisher 304. The method 1500 then ends.

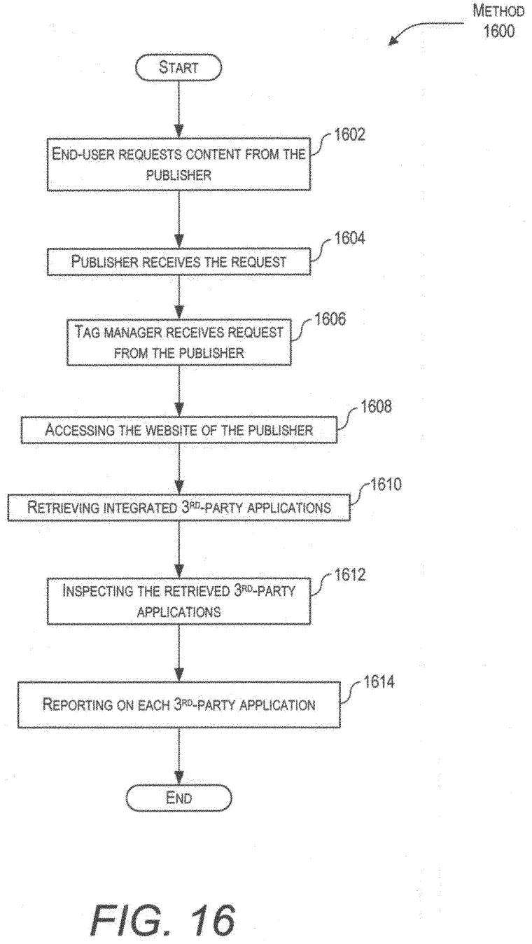

FIG. 16 is a flowchart of an example of another implementation of a method 1600 performed by the content server 308 in accordance with the present disclosure. In this example, the content server 308 is operating in the active out-of-band monitoring mode as described in relation to FIG. 14. As with the description related to FIG. 15, in this example, the process will be described in relation to the first end-user 318 and computing device 302 for ease of illustration but it is appreciated that the process would be the same for the other end-users 1002 and 1004 and computing devices 1008 and 1016.

In this example, the content server 308 is deployed in the same way as the monitoring mode shown in FIG. 10 except that in this example the content server 308 is integrated with the tag manager 1402 of the website 328 and/or Web app of the publisher 304 such that the tag manager 1402 is in signal communication with the content server 308 via signal path 1404.

The method 1600 starts by the end-user 318 requesting 1602 information content from the publisher 304 via the browser 320 on the computing device 302. The publisher 304 receives 1604 the request from the computing device 302. Since the content server 308 is integrated with the tag manager 1402 of the website 328 and/or Web app of the publisher 304, the tag manager 1402 receives 1606 the request from the computing device 302 via the publisher 304. The tag manager 1402 then accesses 1608 the website 328 or Web app of the publisher 304 that the end-user 318 desires to access and retrieves 1610 any integrated third-party applications from the third-party entities 340 that are linked to the website 328 or Web app. The request from the computing device 302 may be part of the end-user data 238. The retrieved integrated third-party applications from the third-party entities 340 that are linked to the website 328 or Web app are passed to the content server 308. The content server 308 then inspects 1612 (shown as 1414 in FIG. 14) the retrieved third-party applications and produces 1614 a monitoring report 1412 on each third-party entity of the plurality of third-party entities 340 that is linked to the website 328 or Web app of the publisher 304. The method 1600 then ends.

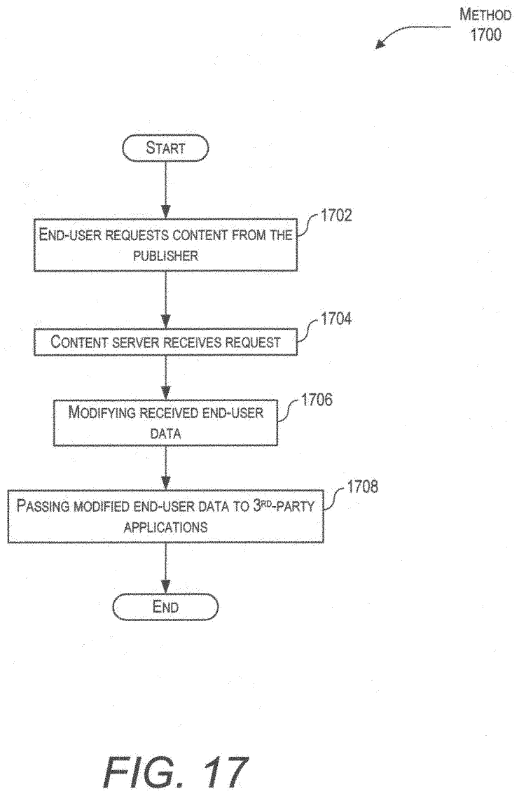

FIG. 17 is a flowchart of an example of yet another implementation of a method 1700 performed by the content server 308 in accordance with the present disclosure. In this example, the content server 308 is operating in active containment mode (as described in relation to FIG. 11) and is configured to provide privacy and compliance protection by ensuring that active web site 328 content for the customer data 1034 is contained when being delivered to the endpoint browser (i.e., browser 320, 1010, or 1018). As with the descriptions related to FIGS. 15 and 16, in this example, the process will be described in relation to the first end-user 318 and computing device 302 for ease of illustration but it is appreciated that the process would be the same for the other end-users 1002 and 1004 and computing devices 1008 and 1016.

The method 1700 starts by the end-user 318 requesting 1702 information content from the publisher 304 via the browser 320 on the computing device 302. The content server 308 receives 1704 the request from the computing device 302 because the content server 308 is acting as a proxy server for the publisher 304. The request from the computing device 302 may be part of the end-user data 238. In this example, the end-user data 238 is prevented from being directly entered into the website 328 or Web app of the publisher 304 and is first passed to the content server 308 which modifies 1706 the end-user data 238 before providing the modified end-user data 238 to the website 328 which is then passed 1708 to the third-party entities 340 via signal path 1102. The method 1700 then ends.

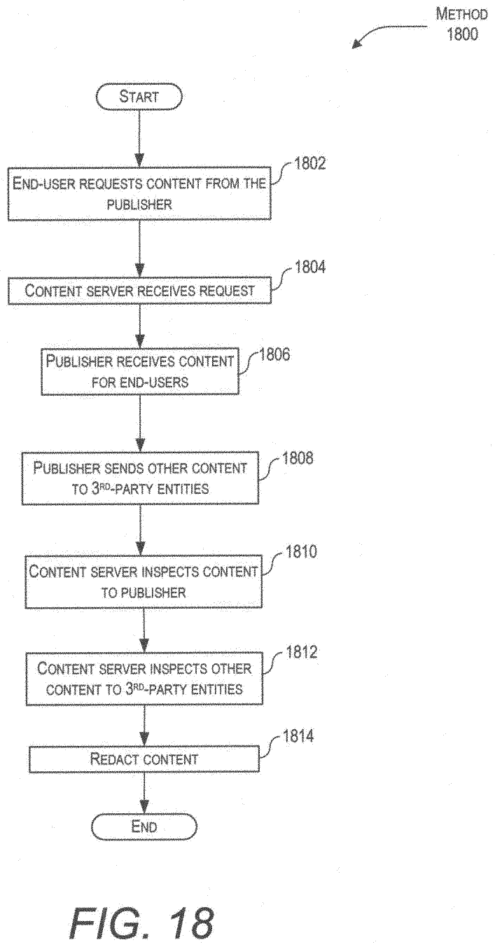

FIG. 18 is a flowchart of an example of yet another implementation of a method 1800 performed by the content server 308 in accordance with the present disclosure. In this example, the content server 308 is configured for anomaly detection (as described in relation to FIG. 12) and provides inspection of content 1200 and 1202 being delivered both to the computing devices 302, 1008, and 1016 of the end-users 318, 1002, and 1004 and the third-party providers of the third-party entities 340, detecting when the content 1200 and 1202 differs from what is expected.

The method 1800 starts by the end-user 318 requesting 1802 information content from the publisher 304 via the browser 320 on the computing device 302. The content server 308 receives 1804 the request from the computing device 302 because the content server 308 is acting as a proxy server for the publisher 304. The request from the computing device 302 may be part of the end-user data 238. The publisher 304 also receives 1804 content 1200 form the customers 1006 and website 328 of the publisher sends 1806 other content 1202 to the third-party entities 340. The content server 308 then inspects 1808 the content 1200 to the publisher 304 and inspects 1812 the other content 1202 from the website 328 to the third-party entities 340 specific terms important to the publisher 304—including competitor names, offensive content or other sensitive content types.

Once identified, the content server 308 redact 1814 content 1200 and 1202 without affecting the experience of the end-users 318, 1002, and 1004. As an example, by utilizing anomaly detection, the content server 308 may prevent 1204 potential customer 1006 hijacks from a website 1206 of a competitors. Moreover, the content server 308 can identify tracking applications and/or advertising plug-ins of competitors, remove third-party redirection from the website 328 of the publisher 304 by competitors, and preserve the customers 1006 on the website 328 or Web app of the publisher 304. The method 1800 then ends.

It should be noted that a modification to the previous embodiments may be made to deal with the use of intelligent tracking prevention (“ITP”) technologies developed by Apple Computers, Inc. At present, ITP 2.0 functionally has two major implications for online advertising that include elimination of a 24-hour 3rd-party cookie retention policy, completely preventing the use of existing methods for tracking/re-targeting; and downgrading of precise referring information to the domain reference only, so that the exact referring page becomes unknown.

In order to deal with ITP 2.0 technologies, the content server 308 may utilize first-party subdomains instead of third-party ones: for each publisher example.com, the required third-party interactions are delivered via a new domain “3rdparty.example.com” (instead of the current links using “3rdparty.com”). The content server 308 may convert all original content from “3rdparty.com” to point to “3rdparty.example.com” including each and every link that is contained or dynamically generated within the 3rdparty.com tags/scripts. As an example of implementation, the content server 308 may perform the following steps that include: the publisher 304 creates “3rdparty.example.com” domain and delegates it to the content server 308 via a DNS configuration; 3rdparty.com modifies its tags/scripts to use 3rdparty.example.com for example.com content and communicates these changes to the publisher 304; and the content server 308 creates a cloud service to transparently convert all interactions within 3rdparty.example.com tags to be delivered to 3rdparty.com and all of its partners (if applicable). In order to deliver detailed referring information, the content server 308 can create a special HTTP header, which would contain the full REFERER (in an obfuscated/encrypted manner, if needed), or it modifies the request URL to include the referring information as a request URL parameter.

Using the first-party (i.e., the publisher 304) main domain instead of third-party ones only for those end-users who are affected by ITP and similar technologies: for each publisher example.com, the required third-party interactions are delivered via the same domain example.com (instead of the current links using 3rdparty.com), but only after detecting that the end-user can be affected by ITP restrictions. The disclosed system employs a transparent content server 308, converting all original content from 3rdparty.com to point to example.com, including each and every link that is contained or dynamically generated within the 3rdparty.com tags/scripts. The steps for this example process includes: the publisher 304 configures its CDN service for its domain, example.com, to use the content server 308 as a gatekeeper (instead of the true origin), or delegates example.com to the disclosed system via a DNS configuration; the content server 308 creates a cloud service to transparently convert all interactions within 3rdparty.com tags to become requests to example.com, and thus handled by the content server's 308 rewriting engine; the content server 308 gets a request for a webpage on example.com and determines whether the end-user is affected by ITP; and content for end-users not affected by ITP is left unchanged, while content for ITP-affected end-users is rewritten, so that all relevant third-party interactions are handled by content server 308.

In order to deliver detailed referring information to all parties, the content server 308 can create a special HTTP header, which would contain the full REFERER (in an obfuscated/encrypted manner, if needed), or it modifies the request URL to include the referring information as a request URL parameter.

In some instances, one system or method may be more straightforward in dealing with the publisher's procedures; for example, when all end-users are handled by the domain 3rdparty.example.com, it might preclude 3^{rd}-parties entities from continuing to use the existing id-syncing solutions for interactions not affected by ITP 2.0. Therefore, id syncing may be handled outside of the domain 3rdparty.example.com by using DigiTrust or some other identification management solution.

Alternative approaches may be utilized by the content server 308 in dealing with issues such as preservation of cookies and cross-domain tracking. In this example, cooperating parties can implement the following process of cookie syncing. In order to determine that the end-user accessing site A.com has already been encountered on the system, the content server 308 may insert a special request to a previously chosen site C.com which acts as a main id-syncing site. Usually, C.com is the most popular site among all sites handled by the content server's 308 first-domain approach. Such “syncing” request should be done only once, per domain, per end-user, so that the standard ITP AI algorithms would not be triggered. In this example, it is important to avoid inserting requests to C.com into each and every webpage.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as example implementations of such techniques.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Moreover, the operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A content server for providing application unification for one or more public network sites and applications being accessed by a computing device over a public network, the content server comprising:
one or more processing units;
computer-readable media storing instructions that, when executed by the one or more processing units, cause the content server to perform operations comprising:
receiving, as an intermediary, a request from the computing device for information content from a specific public network site of the one or more public network sites and applications;
requesting the information content from the specific public network;
receiving, from the specific public network, the information content within a first data;
detecting a link for external information within the information content, wherein the external information is located on an external server that is external to the specific public network;
receiving the external information from the external server;
modifying the information content with the external information to produce a modified information content; and
sending the modified information content to the computing device.

2. The content server of claim 1, further including
a proxy domain content rewriting engine,
a javascript execution engine, and
a machine-learning module.

3. The content server of claim 1, wherein the content server is a proxy server having one or more servers acting as an intermediary between the computing device, the specific public network site, and the external server that is external to the specific public network.

4. The content server of claim 3, wherein a server of the content server includes
a first server module configured to receive, from the computing device, a domain name resolution request for the specific public network site, wherein the first server module is configured to request a first data from the specific public network site,
a second server module configured to
receive, from the specific public network site, a first data,
detect if the first data has any redirects to third-party entities, and
produce a second data by rewriting the first data to remove the redirects,
a third server module configured to
request information data from a third-party entity that the redirect was directed to, and
receive the information data, and
combine the received information data with the second data, and
transmit the combined received information data with the second data to the computing device.

5. The content server of claim 3, wherein a server of the content server includes
means for requesting a first data from the specific public network site,
means for receiving, from the specific public network site, a first data,
means for detecting if the first data has any redirects to third-party entities, and
means for producing a second data by rewriting the first data to remove the redirects,
means for requesting information data from a third-party entity that the redirect was directed to,
means for receive the information data,
means for combine the received information data with the second data, and
means for transmit the combined received information data with the second data to the computing device.

6. The content server of claim 4, wherein the third server module is further configured to cleanse user data from the computing device before sending the cleansed user data to the third-party entity.

7. A method for providing application unification for one or more public network sites and applications being accessed by a computing device over a public network with a content server, the method comprising:
receiving, as an intermediary, a request from the computing device for information content from a specific public network site of the one or more public network sites and applications;
requesting the information content from the specific public network;
receiving, from the specific public network, the information content within a first data;
detecting a link for external information within the information content, wherein the external information is located on an external server that is external to the specific public network;
receiving the external information from the external server;
modifying the information content with the external information to produce a modified information content; and
sending the modified information content to the computing device.

8. The method of claim 7, wherein the content server is a proxy server having one or more servers, the method further comprising
acting as an intermediary between the computing device, the specific public network site, and the external server that is external to the specific public network with a server of the one or more servers.

9. The method of claim 8, wherein a server of the content server includes a first server module, a second server module, and a third server module, wherein the method further includes
receiving, from the computing device with the first server module, a domain name resolution request for the specific public network site,
requesting a first data from the specific public network site,
receiving, from the specific public network site with the second server module, a first data,
detecting if the first data has any redirects to third-party entities,
producing a second data by rewriting the first data to remove the redirects,
requesting information data from a third-party entity with the third server module, which the redirect was directed to,
receiving the information data,
combining the received information data with the second data, and
transmitting the combined received information data with the second data to the computing device.

10. The method of claim 9, further including cleansing user data from the computing device before sending the cleansed user data to the third-party entity.

11. A method of claim 7, further including
using one or many first-party subdomains instead of third-party ones for each specific public network site, wherein the required third-party interactions are delivered via a new domain instead of the current links; and
converting all original content from third-party to replace one or more of the links contained in the original content or dynamically generated within the third-party tags/scripts to use the first-party subdomains.

12. A content server for providing application unification for one or more public network sites and applications being accessed by a computing device over a public network, the content server comprising:
means for receiving, as an intermediary, a request from the computing device for information content from a specific public network site of the one or more public network sites and applications;
means for requesting the information content from the specific public network;
means for receiving, from the specific public network, the information content within a first data;
means for detecting a link for external information within the information content, wherein the external information is located on an external server that is external to the specific public network;
means for receiving the external information from the external server;
means for modifying the information content with the external information to produce a modified information content; and
means for sending the modified information content to the computing device.

13. The method of claim 12, further including
a proxy domain content rewriting engine,
a javascript execution engine, and
a machine-learning module.

14. The content server of claim 12, wherein the content server is a proxy server having one or more servers acting as an intermediary between the computing device, the specific public network site, and the external server that is external to the specific public network.

15. The content server of claim 14, wherein a server of the content server includes
a first server module configured to receive, from the computing device, a domain name resolution request for the specific public network site, wherein the first server module is configured to request a first data from the specific public network site,
a second server module configured to
receive, from the specific public network site, a first data,
detect if the first data has any redirects to third-party entities, and
produce a second data by rewriting the first data to remove the redirects,
a third server module configured to
request information data from a third-party entity that the redirect was directed to, and
receive the information data, and
combine the received information data with the second data, and
transmit the combined received information data with the second data to the computing device.

16. The content server of claim 15, wherein the third server module is further configured to cleanse user data from the computing device before sending the cleansed user data to the third-party entity.
